(19) United States
(12) Patent Application Publication
(10) Pub. No.: US 2026/0064834 A1
(43) Pub. Date: Mar. 5, 2026

(54) DETERMINATION OF RISK MITIGATION TECHNIQUES FOR UPDATING APPLICATIONS HOSTED ON CONTAINER PLATFORMS

(71) Applicant: International Business Machines Corporation, Armonk, NY (US)

(72) Inventors: David Rowland Bell, Southampton (GB); Arthur James Barr, Basingstoke (GB); Stephen David Marshall, Lee-On-the-Solent (GB); Luke James Powlett, Romsey (GB)

(21) Appl. No.: 18/821,481

(22) Filed: Aug. 30, 2024

(51) Int. Cl. G06F 21/55; G06F 8/65; G06F 21/57

(52) U.S. Cl. CPC G06F 21/554; G06F 8/65; G06F 21/577; G06F 2221/033

(57) ABSTRACT

A method and a system for determination of risk mitigation techniques for updating applications hosted on container platforms is provided. The method comprises receiving a first input associated with an update of one or more elements of a plurality of elements associated with a configuration of an application hosted on a container platform. The method further comprises calculating, a first risk score based on the received first input, the first risk score is associated with the update of the one or more elements of the plurality of elements associated with the configuration of the application. Further, the method comprises determining a first set of risk mitigation techniques based on the calculated first risk score. The method further comprises outputting the determined first set of risk mitigation techniques.

### BACKGROUND

The disclosure relates to risk mitigation and more particularly, to determination of risk mitigation techniques for updating applications hosted on container platforms.

Modern applications frequently rely on container platforms such as Kubernetes® and Red Hat® OpenShift® for deployment and management. These platforms provide automated operations including application installation, monitoring, and failure recovery. However, updating applications on these platforms presents significant risks. Existing approaches mainly focus on general security vulnerabilities and software development risks, often overlooking the specific risks associated with configuration and version changes during updates. These risks include incompatibility issues, dependency conflicts, and improper handling of stateful data.

As a result, application operators face uncertainties and potential disruptions, risking downtime, degraded performance, data loss, or application failure during updates. Moreover, there is no unified approach to evaluate the likelihood of errors during updates. This gap necessitates a manual oversight process, increasing the potential for human error and insufficiencies, highlighting the need for better risk assessment and mitigation specific to the container platforms such as Kubernetes® and OpenShift® updates.

### SUMMARY

According to an embodiment of the disclosure, a computer-implemented method for determination of risk mitigation techniques for updating applications hosted on container platforms is described. The computer-implemented method comprises receiving, by a computer, a first input associated with an update of one or more elements of a plurality of elements associated with a configuration of an application hosted on a container platform. The computer implemented method further comprises calculating, by the computer, a first risk score based on the received first input. The first risk score is associated with the update of the one or more elements of the plurality of elements associated with the configuration of the application. The computer implemented method further comprises determining, by the computer, a first set of risk mitigation techniques based on the calculated first risk score. The determined first set of risk mitigation techniques are to be executed before updating the application. The computer implemented method further comprises outputting, by the computer, the determined first set of risk mitigation techniques.

According to one or more embodiments of the disclosure, a system for determination of risk mitigation techniques for updating applications hosted on container platforms is described. The system performs a method for determination of risk mitigation techniques for updating applications hosted on container platforms. The method comprises receiving a first input associated with an update of one or more elements of a plurality of elements associated with a configuration of an application hosted on a container platform. The method further comprises calculating a first risk score based on the received first input. The first risk score is associated with the update of the one or more elements of the plurality of elements associated with the configuration of the application. The method further comprises determining a first set of risk mitigation techniques based on the calculated first risk score. The determined first set of risk mitigation techniques are to be executed before updating the application. The method further comprises outputting the determined first set of risk mitigation techniques.

According to one or more embodiments of the disclosure, a computer program product for determination of a first set of risk mitigation techniques to be executed before an update of an application hosted on a container platform, the computer program product including a computer-readable storage medium having program instructions embodied therewith, the program instructions executable by a system to cause the system to receive a first input associated with an update of one or more elements of a plurality of elements associated with a configuration of an application hosted on a container platform. The program instructions further cause the system to calculate a first risk score based on the received first input, the first risk score is associated with the update of the one or more elements of the plurality of elements associated with the configuration of the application. The program instructions further cause the system to determine a first set of risk mitigation techniques based on the calculated first risk score. The determined first set of risk mitigation techniques are to be executed before an update of the application. The program instructions further cause the system to output the determined first set of risk mitigation techniques.

### BRIEF DESCRIPTION OF THE DRAWINGS

The following description will provide details of preferred embodiments with reference to the following figures wherein:

FIG. 1 is a diagram that illustrates a computing environment for determination of risk mitigation techniques for updating applications hosted on container platforms, in accordance with an embodiment of the disclosure;

FIG. 2 is a diagram that illustrates an environment for determination of risk mitigation techniques for updating applications hosted on container platforms, in accordance with an embodiment of the disclosure;

FIG. 3 is a diagram that illustrates exemplary operations for determination of risk mitigation techniques for updating applications hosted on the container platforms, in accordance with an embodiment of the disclosure;

FIG. 4 is a diagram that illustrates exemplary operations for creation of canary application based on comparison of risk score with a threshold risk score, in accordance with an embodiment of the disclosure;

FIG. 5 is a diagram that illustrates exemplary operations to update risk score, in accordance with an embodiment of the disclosure;

FIG. 6 is a diagram depicting training of first ML model for the determination of risk mitigation techniques associated with updating of applications hosted on container platforms, in accordance with an embodiment of the disclosure;

FIG. 7A, FIG. 7B, FIG. 7C, and FIG. 7D are exemplary diagrams that collectively depict a user interface associated with the operations for determination of risk mitigation techniques for updating applications hosted on the container platforms, in accordance with an embodiment of the disclosure;

FIG. 8A, FIG. 8B, FIG. 8C, and FIG. 8D are exemplary diagrams that collectively depict user interface associated with the operations for determination of risk mitigation techniques for updating applications hosted on the container platforms, in accordance with an embodiment of the disclosure;

FIG. 9 is a flowchart that illustrates an exemplary method for determination of risk mitigation techniques for updating applications hosted on the container platforms, in accordance with an embodiment of the disclosure.

### DETAILED DESCRIPTION

Modern applications frequently use container platforms such as Kubernetes® and Red Hat® OpenShift® for deployment and management, leveraging their automated capabilities for tasks such as application installation, monitoring, and failure recovery. Despite these benefits, updating these applications bring a lot of challenges. The challenges include data loss while updating the application, downtime for users while updating the application, and failure in updating the application.

Current approaches may tend to focus on general security vulnerabilities and software development risks associated with configuration and version changes during the updates. The existing risk assessment methodologies aim to identify and resolve known security issues, but they fall short in addressing the dynamic risks introduced by the updates. As a result, the disclosed system encounters uncertainties and potential disruptions during the update process. The disclosed system can be an application operator. The application operator is an automated program that performs tasks such as installing the application, monitoring the application, updating, and upgrading the application, and failure recovery of the application. Furthermore, there is a lack of a standardized approach to evaluating the likelihood of issues arising during the updates. Most resources provide general advice and best practices for Kubernetes® upgrades but do not offer detailed risk scoring or automated risk management solutions tailored to these specific scenarios.

To address these issues, there is a need for an automated system that can determine risk mitigation techniques for updating applications hosted on container platforms such as the Kubernetes®. The automated system can be utilized to identify dynamic risks to analyze the specific environments, application configurations, and update process to identify potential risks beyond just known security vulnerabilities. Further, the disclosed automated system can provide a standardized approach to systematically evaluating the likelihood and impact of issues that may arise during the application update process. The system can further determine appropriate risk mitigation techniques and automate their implementation to ensure a smooth and secure application update process.

Such an automated system would need to take a holistic view of the application dependencies, and update workflow to provide comprehensive risk management capabilities. This would help organizations or individual users to address the dynamic risks introduced by application updates and maintain the reliability and security of their containerized applications. By implementing an automated upgrade risk management system, organizations or the individual users can gain better visibility, control, and confidence in the update process, ensuring that application updates are executed safely and with minimal disruption to their containerized infrastructure.

According to an embodiment of the disclosure, a computer-implemented method for determination of risk mitigation techniques for updating applications hosted on container platforms is described. The computer-implemented method comprises receiving, by a computer, a first input associated with an update of one or more elements of a plurality of elements associated with a configuration of an application hosted on a container platform. The computer implemented method further comprises calculating, by the computer, a first risk score based on the received first input. The first risk score is associated with the update of the one or more elements of the plurality of elements associated with the configuration of the application. The computer implemented method further comprises determining, by the computer, a first set of risk mitigation techniques based on the calculated first risk score. The determined first set of risk mitigation techniques are to be executed before updating the application. The computer implemented method further comprises outputting, by the computer, the determined first set of risk mitigation techniques.

In other embodiments of the disclosure, the computer implemented method further comprises retrieving, by the computer, one or more scores associated with the one or more elements based on the received first input. The one or more scores are retrieved from one or more data sources. The computer implemented method further comprises determining, by the computer, a combination operator based on the received first input. The computer implemented method further comprises calculating, by the computer, the first risk score based on the retrieved one or more scores and the determined combination operator.

In other embodiments of the disclosure, the calculation of the first risk score is based on an application of the determined combination operator on the retrieved one or more scores. The determined combination operator corresponds to one of an additive operator, a multiplier operator, or an exponential operator.

In other embodiments of the disclosure, the computer implemented method further comprises determining, by the computer, a first value of a first element of the one or more elements based on the received first input. The computer implemented method further comprises determining, by the computer, a second value of the first element of the one or more elements based on the received first input. The received first input comprises the second value. The computer implemented method further comprises retrieving, by the computer, a first score of the one or more scores associated with the first element based on the determined first value and the determined second value. The first score associated with the update of the first element from the first value to the second value is stored in the one or more data sources.

In other embodiments of the disclosure, the computer implemented method further comprises identifying, by the computer, an absence of a score associated with at least one element of the plurality of elements associated with the configuration of the application hosted on the container platform. The computer implemented method further comprises assigning, by the computer, a default score with each of the at least one element based on the identification.

In other embodiments of the disclosure, the computer implemented method further comprises executing, by the computer, each of the first set of risk mitigation techniques before the update of the application. The computer implemented method further comprises updating, by the computer, the application based on the execution of each of the first set of risk mitigation techniques. The computer implemented method further comprises determining, by the computer, a first result indicative of one of a success or a failure associated with the update of the application. The computer implemented method further comprises updating, by the computer, the one or more scores based on the determined first result.

In other embodiments of the disclosure, the computer implemented method further comprises comparing, by the computer, the calculated first risk score with a threshold risk score. The computer implemented method further comprises determining, by the computer, the first set of risk mitigation techniques based on the comparison.

In other embodiments of the disclosure, the computer implemented method further comprises receiving, by the computer, a second input associated with a selection of one or more risk mitigation techniques of the determined first set of risk mitigation techniques. The computer implemented method further comprises executing, by the computer, the selected one or more risk mitigation techniques based on the received second input. The selected one or more risk mitigation techniques are to be executed before updating of the application.

In other embodiments of the disclosure, the first set of risk mitigation techniques comprises at least one of a creation of a backup of data associated with the application, a creation of a backup of the configuration associated with the application, generation of one or more snapshots associated with the application, execution of one or more preparatory checks, or creation of a set of canary applications associated with the application hosted on the container platform.

In other embodiments of the disclosure, the computer implemented method further comprises creating, by the computer, the set of canary applications based on a determination that the calculated first risk score is greater than a threshold risk score. The set of canary applications are associated with the application hosted on the container platform. The computer implemented method further comprises updating, by the computer, each canary application of the created set of canary applications based on the received first input. The computer implemented method further comprises determining, by the computer, a second result indicative of one of a success or a failure associated with the update of each canary application of the created set of canary applications. The computer implemented method further comprises calculating, by the computer, the first risk score based on the determination of the second result.

In other embodiments of the disclosure, the configuration of each canary application of the created set of canary applications is same as the configuration of the application hosted on the container platform.

According to one or more embodiments of the disclosure, a system for determination of risk mitigation techniques for updating applications hosted on container platforms is described. The system performs a method for determination of risk mitigation techniques for updating applications hosted on container platforms. The method comprises receiving a first input associated with an update of one or more elements of a plurality of elements associated with a configuration of an application hosted on a container platform. The method further comprises calculating a first risk score based on the received first input. The first risk score is associated with the update of the one or more elements of the plurality of elements associated with the configuration of the application. The method further comprises determining a first set of risk mitigation techniques based on the calculated first risk score. The determined first set of risk mitigation techniques are to be executed before updating the application. The method further comprises outputting the determined first set of risk mitigation techniques.

In other embodiments of the disclosure, the system retrieves one or more scores associated with the one or more elements based on the received first input. The one or more scores are retrieved from one or more data sources. The system further determines a combination operator based on the received first input. The system further calculates the first risk score based on the retrieved one or more scores and the determined combination operator.

In other embodiments of the disclosure, the calculation of the first risk score is based on an application of the determined combination operator on the retrieved one or more scores. The determined combination operator corresponds to one of an additive operator, a multiplier operator, or an exponential operator.

In other embodiments of the disclosure, the system further determines a first value of a first element of the one or more elements based on the received first input. The system further determines a second value of the first element of the one or more elements based on the received first input. The received first input comprises the second value. The system retrieves a first score of the one or more scores associated with the first element based on the determined first value and the determined second value. The first score associated with the update of the first element from the first value to the second value is stored in the one or more data sources.

In other embodiments of the disclosure, the system further identifies an absence of a score associated with at least one element of the plurality of elements associated with the configuration of the application hosted on the container platform. The system further assigns a default score with each of the at least one element based on the identification.

In other embodiments of the disclosure, the system further executes each of the first set of risk mitigation techniques before the update of the application. The system further updates the application based on the execution of each of the first set of risk mitigation techniques. The system further determines a first result indicative of one of a success or a failure associated with the update of the application. The system further updates the one or more scores based on the determined first result.

In other embodiments of the disclosure, the system further receives a second input associated with a selection of one or more risk mitigation techniques of the determined first set of risk mitigation techniques. The system further executes the selected one or more risk mitigation techniques based on the received second input. The selected one or more risk mitigation techniques are to be executed before the update of the application.

In other embodiments of the disclosure, the first set of risk mitigation techniques include at least one of a creation of a backup of data associated with the application, a creation of a backup of the configuration associated with the application, generation of one or more snapshots associated with the application, execution of one or more preparatory checks, or creation of a set of canary applications associated with the application hosted on the container platform.

According to one or more embodiments of the disclosure, a computer program product for determination of a first set of risk mitigation techniques to be executed before an update of an application hosted on a container platform, the computer program product including a computer-readable storage medium having program instructions embodied therewith, the program instructions executable by a system to cause the system to receive a first input associated with an update of one or more elements of a plurality of elements associated with a configuration of an application hosted on a container platform. The program instructions further include an instruction to calculate a first risk score based on the received first input, the first risk score is associated with the update of the one or more elements of the plurality of elements associated with the configuration of the application. The program instructions further include an instruction to determine a first set of risk mitigation techniques based on the calculated first risk score. The determined first set of risk mitigation techniques are to be executed before an update of the application. The program instructions further include an instruction to output the determined first set of risk mitigation techniques.

Various aspects of the disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

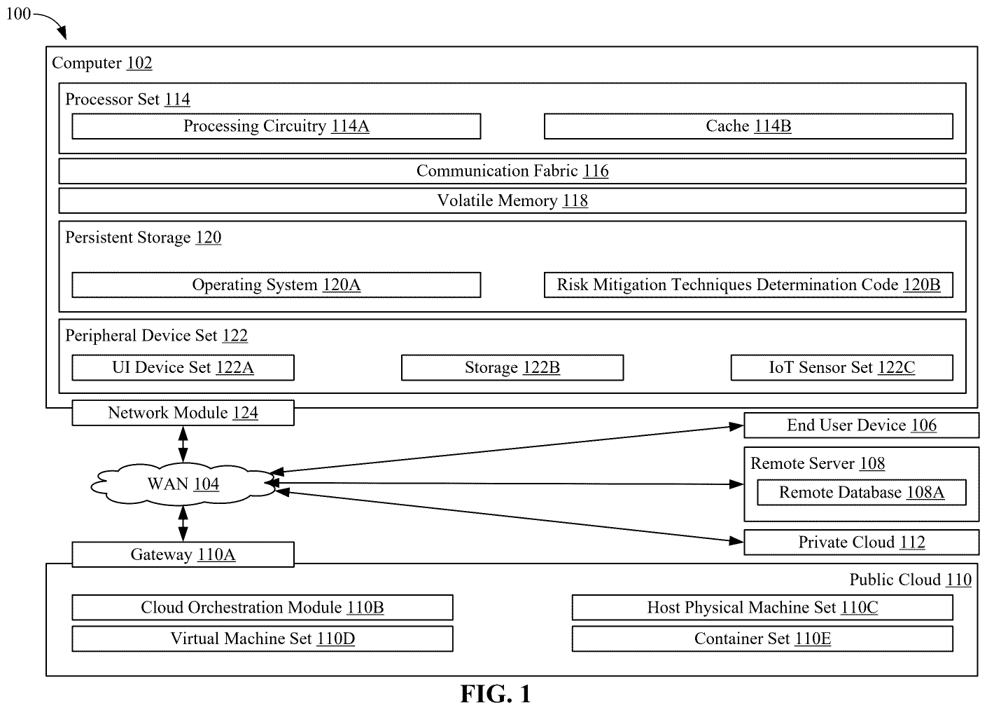

FIG. 1 is a diagram that illustrates a computing environment for determination of risk mitigation techniques for updating applications hosted on container platforms, in accordance with an embodiment of the disclosure. With reference to FIG. 1, there is shown a computing environment 100 that contains an example of an environment for the execution of at least some of the computer code involved in performing the methods, such as a risk mitigation techniques determination code 120B. In addition to the risk mitigation techniques determination code 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the risk mitigation techniques determination code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that is capable of running a program, accessing a network or querying a database, such as a remote database 130. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the methods”). These computer-readable program instructions are stored in various types of computer-readable storage media, such as the cache 114B and the other storage media discussed below. The program instructions, and associated data, are accessed by the processor set 114 to control and direct the performance of the methods. In computing environment 100, at least some of the instructions for performing the methods may be stored in the dynamic modification of the risk mitigation techniques determination code 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the risk mitigation techniques determination code 120B typically includes at least some of the computer code involved in performing the disclosed methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer and another sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In other embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 130 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in other embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

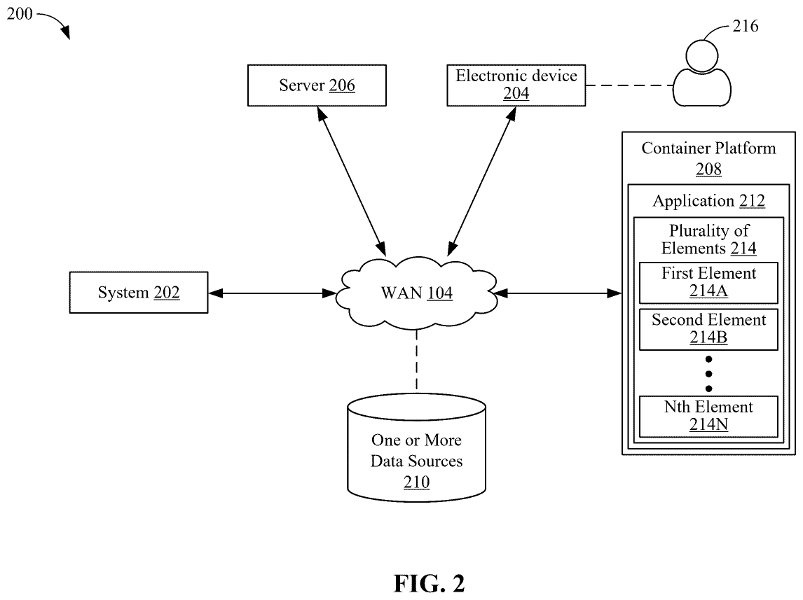

FIG. 2 is a diagram that illustrates an environment for determination of risk mitigation techniques for updating applications hosted on container platforms, in accordance with an embodiment of the disclosure. FIG. 2 is explained in conjunction with elements from FIG. 1. With reference to FIG. 2, there is shown a diagram of a network environment 200. The network environment 200 includes a system 202, an electronic device 204, a server 206, and a container platform 208. There is further shown an application 212 hosted on the container platform 208. The application 212 further comprises a plurality of elements 214. The plurality of elements 214 comprises a first element 214A, a second element 214B, up to an Nth element 214N. With reference to FIG. 2, there is further shown one or more data sources 210 The network environment 200 further comprises the WAN 104 of FIG. 1. In an embodiment of the disclosure, the electronic device 204 may be an exemplary embodiment of the EUD 106. Similarly, the system 202 may be an exemplary embodiment of the computer 102 in FIG. 1.

The system 202 may include suitable logic, circuitry, interfaces, and/or code that may be configured for determination of risk mitigation techniques for updating applications hosted on container platforms. The system 202 receives a first input associated with an update of one or more elements of the plurality of elements 214 associated with a configuration of the application 212 hosted on the container platform 208. The system 202 further calculates a first risk score based on the received first input. The first risk score is associated with the update of the one or more elements of the plurality of elements 214 associated with the configuration of the application 212. The system 202 determines a first set of risk mitigation techniques based on the calculated first risk score. The determined first set of risk mitigation techniques are to be executed before an update of the application 212. The system 202 further outputs the determined first set of risk mitigation techniques. In an exemplary embodiment, the system 202 can be a Kubernetes® operator, a computing device, a server, a computer work-station, or a mainframe machine.

The electronic device 204 may include suitable logic, circuitry, interfaces, and/or code that may be configured to receive the first input from the user 216 associated with the electronic device 204 and transmit the received first input to the system 202. In an embodiment, the electronic device 204 renders the determined first set of risk mitigation techniques received from the system 202 on a display screen associated with the electronic device 204. In an embodiment, the electronic device 204 may include a display screen. In an embodiment, the user 216 may correspond to a stand-alone user or an organization associated with the application hosted on the container platform 208. Examples of the electronic device 204 may include, but are not limited to, a computing device, a server, a computer work-station, a smartphone, a cellular phone, a mobile phone, a mainframe machine, a gaming device, a consumer electronic (CE) device, a head-mounted device, a projection-based system, and/or any other device with computer vision display capabilities.

The display screen may include suitable logic, circuitry, and interfaces that may be configured to render the determined first set of risk mitigation techniques. In some embodiments of the disclosure, the display screen may be an external display device associated with the electronic device 204. The display screen may be a touch screen which may enable the user 216 to provide the first input via the display screen. The touch screen may be at least one of a resistive touch screen, a capacitive touch screen, or a thermal touch screen. In accordance with an embodiment of the disclosure, the display screen may refer to a display screen of a head-mounted device (HMD), a smart-glass device, a see-through display, a projection-based display, an electro-chromic display, or a transparent display. In some embodiments of the disclosure, the display screen may be realized through several known technologies such as, but are not limited to, at least one of a Liquid Crystal Display (LCD) display, a Light Emitting Diode (LED) display, a plasma display, or an Organic LED (OLED) display technology, or other display devices.

The server 206 may include suitable logic, circuitry, and interfaces, and/or code that is configured to host the container platform 208. In an exemplary embodiment, the server 206 is implemented as a cloud server and may execute operations through web applications, cloud applications, Hypertext Transfer Protocol (HTTP) requests, repository operations, file transfer, and the like. Other example implementations of the server 206 includes, but are not limited to, a database server, a file server, a web server, a media server, an application server, a mainframe server, or a cloud computing server.

In an embodiment, the server 206 stores at least data associated with the application 212, one or more scores associated with the each of the plurality of elements 214 of the application 212 hosted on the container platform 208, the risk score associated with the update of the application 212 that is calculated by the system 202, and combination operators associated with the update of more than one element of the plurality of elements 214. In an exemplary embodiment, the server 206 is coupled with the one or more data sources 210. In an embodiment, the system 202 retrieves the data from the one or more data sources 210 for the update of the application 212. In an exemplary embodiment, if the user 216 requests the update of the first element 214A of the application 212, where the first element 214A corresponds to “spec.version”, then the system 202 may retrieve the one or more scores associated with the update of the “spec.version” to a specific version (such as version 1.0 or version 2.0). The one or more data sources 210 may further include one or more scores associated with update of “spec.version” from a first version to a second version (such as, from version 1.0 to version 2.0 or from version 2.0 to version 3.0). In an exemplary embodiment, the first version corresponds to version 1.0 and the second version corresponds to version 2.0.’

In another embodiment, the set or risk mitigation techniques associated with the risk scores may be stored in the one or more data sources 210. The system 202 may retrieve the first set of risk mitigation techniques associated with the calculated first risk score from the one or more data sources 210.

In an embodiment of the disclosure, the server 206 is implemented as a plurality of distributed cloud-based resources by use of several technologies that are well known to those ordinarily skilled in the art. A person with ordinary skill in the art will understand that the scope of the disclosure is not limited to the implementation of the server 206 and the system 202 as two separate entities. In certain embodiments, the functionalities of the server 206 can be incorporated in its entirety or at least partially in the system 202, without a departure from the scope of the disclosure.

The container platform 208 suitable logic, circuitry, and interfaces, and/or code that may be configured to host the application. Generally, the container platform 208 is a software framework that enable the deployment, management, and scaling of containerized applications (such as the application 212). The container platform 208 provides a consistent runtime environment by encapsulating the application 212 and their dependencies within containers, ensuring seamless operation across various computing environments. These platforms offer tools and services for orchestrating containers, optimizing resource utilization, and automating tasks such as scaling and fault tolerance. Examples of different types of the container platform 208 include but not limited to, container engines (such as docker), container orchestrators (such as the Kubernetes® and OpenShift®), and managed container platforms.

In an embodiment, the application 212 includes the plurality of elements 214. The plurality of elements 214 include the first element 214A, the second element 214B, up to the Nth element 214N. The plurality of elements 214 specify the configurations of the hosted application 212. Specifically, configuring the application 212 hosted on the container platform 208 involves several key steps to ensure it runs efficiently and reliably. Firstly, a docker file is created to define the environment of the application 212, dependencies, and necessary instructions to build the application image. This image is then pushed to a container registry. Further, deployment configurations, typically using YAML files, are crafted to define the desired state of the application, specifying details such as the number of replicas, resource limits, and networking requirements. Such configurations are applied using container orchestration tools like Kubernetes®, which manage the deployment, scaling, and operation of the application containers across a cluster of nodes. Additional configurations might include setting up persistent storage, configuring environment variables and secrets for sensitive data, and setting up monitoring and logging to track the application's performance and health. Furthermore, networking configurations, including service definitions and ingress rules, ensure that the application is accessible to users and other services. In an embodiment, the plurality of elements 214 may be added in a markup language such as, but not limited to, a Yet Another Markup Language (YAML) file, Hypertext Markup Language (HTML) file, Extensible Hypertext Markup Language (XHTML) file, and XML Metadata Interchange (XML) file. A markup language file in an application 212 hosted on the container platform 208 is a configuration file used to describe requirements and settings of the application 212. In an embodiment, the user 216 can modify the configuration of the application 212 by modifying the plurality of elements in the markup language file.

In operation, the system 202 receives the first input associated with an update of one or more elements of the plurality of elements 214 associated with a configuration of the application 212 hosted on the container platform 208. In an embodiment, the system 202 receives the first input from the user 216 via the electronic device 204 associated with the user 216. The first input corresponds to the updating process of the application 212 hosted on the container platform 208. In an embodiment, the first input received by the system 202 from the user 216 includes one or more elements of the plurality of elements that the user 216 wants to update in the application 212 hosted on the container platform 208. In an exemplary embodiment, one or more elements correspond to the first element 214A, second element 214B, up to the Nth element 214N. Each element of the one or more elements is associated with the configuration of the application 212.

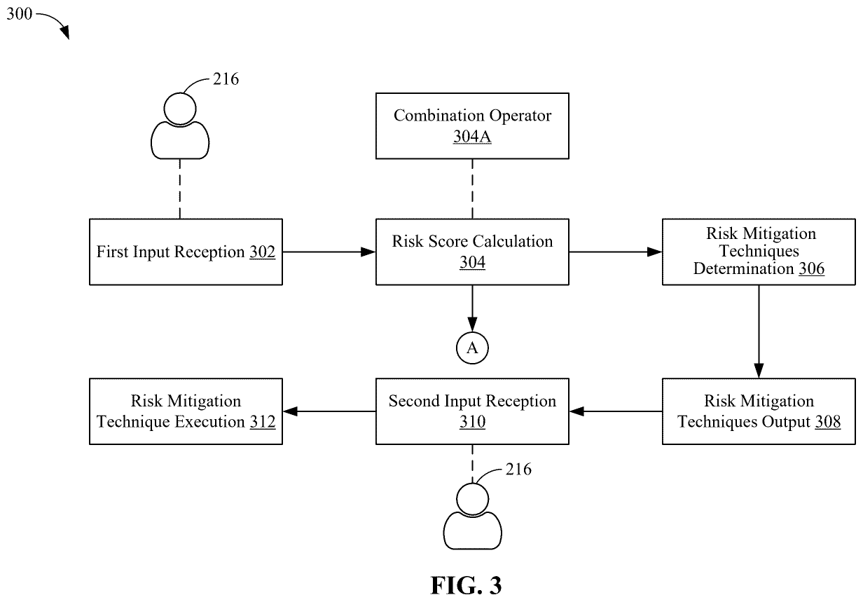

In an exemplary embodiment, the system 202 receives the first input from the user 216 via the electronic device 204, the first input is associated with the update of the one or more elements of the plurality of elements 214. Each of the plurality of elements 214 corresponds to an individual field in the markup language file. As discussed above, the one or more fields of the markup language file collectively represents configuration and setting of the application 212. Details about the one or more elements are provided, for example, in FIG. 3.

In an exemplary embodiment, the user 216 may wish to update a specific field within the markup language file, for example the first element 214A of the plurality of elements 214, then the system 202 receives the first input from the user 216. The first input corresponds to the update of the first element 214A. In an exemplary embodiment, the first input is in a “key: value” pair format. In an exemplary embodiment, the “key: value” pair corresponds to the field name that needs to be updated and a new value associated with the corresponding field name. For example, if the user wishes to update version field of the application 212 from version 1.0 to 2.0, then first input corresponds to “spec.version: 1.0”. Such update may be risky and may result in a variety of issues such as application being unavailable/inaccessible, at least one functionality of the function unavailable, and the like.

To address this issue, the system 202 calculates the first risk score based on the received first input. The risk score indicates the level of risk that is involved with the update requested by the user 216. Based on the calculated first risk score, the system 202 determines the first set of risk mitigation techniques. Each of the first set of risk mitigation techniques are executed before updating the application 212. In an embodiment, the risk mitigation techniques correspond to specific actions and strategies employed by the system 202 to reduce the likelihood and impact of potential risks that could harm the application 212 during or after the update of the application 212. The risk mitigation techniques aim to proactively manage uncertainties and minimize potential losses by identifying, assessing, and addressing potential risks associated with the update of the application. Details about the risk mitigation techniques are provided, for example, in FIG. 3

In an embodiment, the first set of risk mitigation techniques include at least one of a creation of a backup of data associated with the application, a creation of a backup of the configuration associated with the application 212, generation of one or more snapshots associated with the application 212, execution of one or more preparatory checks, creation of a set of canary applications associated with the application 212 hosted on the container platform 208, and the like. The system 202 outputs the determined first set of risk mitigation techniques. In an embodiment, the system 202 renders the first set of risk mitigation techniques on the electronic device 204 associated with the user 216.

FIG. 3 is a diagram that illustrates exemplary operations for determination of risk mitigation techniques for updating applications hosted on the container platforms, in accordance with an embodiment of the disclosure. FIG. 3 is explained in conjunction with elements from FIG. 1, and FIG. 2. With reference to FIG. 3, there is shown a block diagram 300 that illustrates exemplary operations from 302 to 312, as described herein. The exemplary operations illustrated in the block diagram 300 may start at 302 and may be performed by any computing system, apparatus, or device, such as by the computer 102 of FIG. 1 or system 202 of FIG. 2. Although illustrated with discrete blocks, the exemplary operations associated with one or more blocks of the block diagram 300 may be divided into additional blocks, combined into fewer blocks, or eliminated, depending on the particular implementation.

In an embodiment, the user 216 who may be an owner or an administrator of the application 212 hosted on the container platform 208 may wish to update the configuration of the application 212. Updating the configuration of application 212 may be challenging as there can be various risks associated with the updating of the application 212. Such risks may include, but are not limited to, Downtime and Service Disruption, Compatibility Issues, Data Loss or Corruption, Security Vulnerabilities, Performance Degradation, Configuration and Environment Inconsistencies, Rollback Complications, Dependency Conflicts, Resource Overload, and the like. To mitigate such risks, the user 216 may wish to determine and execute a set of risk mitigation techniques associated with the update. The process of determining and executing the set of risk mitigation techniques start at 302.

At 302, a first input reception operation is executed. In the first input reception operation, the system 202 receives the first input associated with the update of one or more elements of the plurality of elements 214. Each of the plurality of elements 214 is associated with the configuration of the application 212 hosted on the container platform 208. As discussed above, the configuration of the application 212 hosted on the container platform 208 may refer to the process of defining and managing various settings and parameters that determines how the application 212 will run within the container environment. The configuration of the application involves configuration of various key components such as Container Image Definition, Container Orchestration, Resource Allocation, Networking, Storage Configuration, Environment Variables, Scaling and Load Balancing, Monitoring and Logging, and Access Control and Security. Details about the configuration of the application 212 hosted on the container platform 208 is known in the art and have been omitted for the sake of brevity.

In an embodiment, the configuration of the application 212 may be done using a markup language file that includes the plurality of elements 214. The markup language file includes an API version that may be used for the configuration of the application 212. In an embodiment, the user 216 may wish to update the one or more elements of the plurality of elements 214. An example of the markup file (specifically a YAML file) associated with the configuration of QueueManger is provided below:
apiVersion: mq.abc.com/v1beta1
kind: QueueManager
metadata:
   name: exampleqm
spec:
   license:
      accept: false
      license: L-AMRD-XXXXX
      use: Production
   queueManager:
      name: EXAMPLEQM
      mqsc:
         -configMap:
         name: example-tls-configmap
         items:
         -example-tls.mqsc
      ini:
         -configMap:
         name: example-tls-configmap
         items:
         -example-tls.ini
      storage:
         queueManager:
         type: ephemeral
   version: 9.3.5.1-r1
pki:
   keys:
      -name: default
         secret:
         secretName: example-qm-tls
         items:
         -tls.key
         -tls.crt
         -ca.crt
telemetry:
   tracing:
      instana:
         enabled: true

Specifically, the above-mentioned YAML configuration file sets up a MQ Queue Manager named “exampleqm” on a Kubernetes® cluster. It specifies the version as “9.3.5.1-r1”. The licensing information indicates that the license “L-AMRD-XXXXX” is for production use but not yet accepted. The Queue Manager, internally named “EXAMPLEQM”, uses ephemeral storage and pulls “Message Queue Script Command (MQSC)” and “Initialization File (INI)” configurations from a ConfigMap named “example-tls-configmap”. For security, it references a Kubernetes® Secret “example-qm-tls” containing TLS key materials. Additionally, telemetry settings enable tracing with “Instana”. This configuration ensures the Queue Manager operates with specified resources, security, and monitoring setups within the container platform 208.

In an embodiment, the configuration (and/or settings) associated with the application 212 are listed in the markup language file (such as the YAML file) in form of the plurality of elements 214 (such as, the first element 214A, the second element 214B, up to the Nth element 214N). Each of the plurality of elements 214 are in the “key: value” pair form. Examples of the “key: value” information of the plurality of elements 214 are, but not limited to, the “spec.version: 9.3.5.1-r1”, and “spec.pki.keys.name: default”.

In an embodiment, the “key: value” pair such as “spec.version: 9.3.5.1-r1” indicates major number, minor number, patch number, and revision number of the application 212. In an exemplary embodiment, the major number corresponds to 9, the minor number corresponds to 3, the patch number corresponds to 5, and the revision number corresponds to 1. The value of the major number may be indicative of significant changes such as new features or substantial modifications that may be added to an existing functionality of the application 212. The value of the minor number reflects the addition of new features or enhancements that may be backward compatible. The patch number may be used for small changes, bug fixes, or minor improvements that do not add new features to the application 212 and the revision number may be used to denote specific builds or iterations of the application 212, which may include internal changes, fixes, or updates that are not significant enough to warrant a change in the patch number. Further, r1 corresponds to a custom tag added for additional versioning information of the application 212. In another embodiment, the “key: value” pair such as “spec.pki.keys.name: default” indicates the name (such as “default”) or identifier of a specific key in Public Key Infrastructure (PKI).

Further, in an exemplary scenario, the user 216 of the application 212 may decide to update the configuration of the application 212 by updating the first element 214A. By way of example and not limitation, the first element 214A may correspond to the version of the application 212. At a first timestamp, the “key: value” pair associated with the version of the application 212 is “spec.version: 9.1”. At a second timestamp, the user 216 initiates an update process to update the configuration of the application 212 by providing the first input to the system 202. To update the version of the application 212, the user 216 provides a request to the system 202 via the electronic device 204. The user 216 may utilize user interface (UI) that may be rendered on the electronic device 204 to input new “key: value” pair (such as, “spec.version: 9.2”) as the first input to make the request for the update of the application 212.

In an embodiment, the first input may be received as an application programming interface (API) call from the electronic device 204 associated with the user 216. This may be possible because the API calls and YAML code may be fundamentally related in Kubernetes® as they both are used to interact with and configure the Kubernetes® cluster that may host the application 212.

At 304, a risk score calculation operation is executed. In the risk score calculation operation, the system 202 calculates the first risk score based on the received first input by the user 216. The first risk score may be associated with the update of the one or more elements (or the first element 214A) of the plurality of elements 214 associated with the configuration of the application 212.

In one exemplary embodiment, once the system 202 receive the first input, the system 202 may initiate the calculation of the first risk score. For example, if the user 216 requests for the update of the first element 214A of the application 212, where the first element 214A corresponds to the “key: value” pair indicative of the “spec.version” of the application 212, then the system 202 retrieves a first score associated with the update of the first element 214A based on the received first input. The first score may be retrieved from one or more data sources 210. In an exemplary embodiment, the score may be a first pre-determined risk score associated with update of the first element 214A of the plurality of elements 214. In an embodiment, the one or more data sources 210 store the pre-determined risk score associated with update of each of the plurality of elements 214. In an exemplary embodiment, a development and support team of the container platform 208 and/or application 212 may determine a score associated with update of each of the plurality of elements 214 and further store the determined score in the one or more data sources 210. In another exemplary embodiment, a machine learning model may be used to determine the score associated with update of each of the plurality of elements 214 based on event data associated with historical update events.

By way of example and not limitation, the first risk score associated with the update of the first element 214A may be stored as a first field as follows:
spec.version
type:addition
riskScore: 5
specificValueRiskScore:
2.0.0: 15
2.0.2: 1

The above exemplary first field shows that updating the version of the application 212 is associated with the combination operator (“type”) that corresponds to addition (or additive operator). Further, the risk score associated with updating “spec.version” may have the pre-determined risk score of 5. In an exemplary embodiment, if the user 216 wants to update the version of the application 212 to a specific version such as, “spec.version: 2.0.0”, then the risk score associated with the update corresponds to 15. In another exemplary embodiment, if the user 216 wants to update the version of the application 212 to a specific version such as, “spec.version: 2.0.2”, then the risk score associated with the update corresponds to 1.

In an embodiment, the user 216 may be able to override a pre-determined risk score associated with update of each of the plurality of elements 214 of the application 212. By way of example and not limitation, the user 216 can assign a higher risk score to update specific versions if the user 216 assess that those updates are riskier. For example, while a default risk score (or the pre-determined risk score) of 5 may be associated with updating the version of the application 212, the user 216 can override the default risk score and modify the risk score. In an exemplary scenario, if the user 216 considers updating to “spec.version: 2.0.2” to be significantly riskier than updating to “spec.version: 2.0.1”, then the user 216 can assign the risk score of 15 for that version instead of default risk core of 1. Similarly, if the user 216 considers updating to “spec.version: 2.0.2” to be less risky than updating to “spec.version: 2.0.1”, then the user 216 could assign a lower risk score (say 0.5) to the corresponding update.

In an embodiment, the system 202 retrieves the first score associated with the first element 214A from the one or more data sources 210. For example, if the user 216 initiates the update process of the first element 214A that corresponds to “spec.version”, then the system 202 retrieves the first score associated with the update of first element 214A of the application 212 from the one or more data sources 210. In an exemplary embodiment, if the retrieved first score from the one or more data sources 210 is 20, then the system 202 determines the first set of risk mitigation techniques corresponding to the first score that. Each of the first set of risk mitigation techniques may have to be executed before updating the first element 214A of the application 212 to mitigate risks.

In an exemplary scenario, if the system 202 identifies an absence of the first score associated with the first element 214A, then the system 202 assigns a default score with the first element 214A based on the identification. Example of the default score can be, but not limited to, 1, 10, 20, or 100. In such a case, the default score may be considered as the risk score.

In another exemplary embodiment, the user 216 of the application 212 requests to update more than one element of the plurality of elements 214 associated with the application 212. Specifically, the user 216 provides as input the first input to the system 202. The first input includes “key: value” pair associated with update of the first element 214A and the second element 214B. The first element 214A corresponds to the “key: value” pair associated with the “spec.version”, and the second element 214B corresponds to the “key: value” pair associated with the “spec.storage.type”. For example, the user 216 initiates the update process to update the first element 214A from “spec.version: 8.1” to “spec.version: 9.0” and the second element 214B from “spec.storage.type: persistent” to “spec.storage.type: ephemeral”. The persistent storage type may indicate a storage that persists across restarts of the pod, node, or even the entire cluster of the application 212. Further, the ephemeral storage is temporary or short-lived.

In an embodiment, the system 202 further determines a first value of the first element 214A based on the received input. In an exemplary embodiment, the first value associated with the first element 214A is “8.1”. The system 202 further determines a second value of the first element 214A based on the received first input. In an exemplary embodiment, the second value associated with the first element 214A is “9.0”. Further, the system 202 retrieves the first score associated with the update of the first element from the determined first value and the determined second value. As discussed above, the first score associated with the update of the first element 214A from the first value to the second value may be stored in the one or more data sources 210. Similarly, the system 202 retrieves a second score associated with the update of the second element 214B from the one or more data sources 210 based on the determined first value and second value associated with the second element 214B.

In an exemplary embodiment, the system 202 further determines a combination operator 304A based on the first input. The combination operator 304A may correspond to a mathematical operator that may be used to calculate the risk score. By way of example and not limitation, the combination operator 304A corresponds to one of an additive operator, a multiplier operator, or an exponential operator. In an embodiment, the combination operator 304A may be indicative of a risk associated with the update of the corresponding element in the application 212. For example, if the combination operator 304A associated with the update of the first element 214A corresponds to the additive operator, then this may indicate that updating the first element 214A may be the low-risk update. Further, if the combination operator 304A associated with the update of the second element 214B corresponds to the multiplier operator, then this may indicate that updating the second element 214B may be the high-risk update. As another example, if the combination operator 304A associated with the update of a third element corresponds to the exponential operator, then this may indicate that updating the third element may be the very high-risk update.

The system 202 may further utilize the combination operator to calculate the first risk score associated with the update of the first element and the second element of the application 212. In an exemplary scenario, the first score associated with the update of first element 214A is 50, and the second score associated with the update of the second element 214B is 10. Further, the system 202 determines the combination operator 304A based on the received first input. By way of example and not limitation, if the combination operator corresponds to the multiplicative operator, then the first risk score associated with the update of the first element 214A and the second element 214B is calculated to be 500 (as 50*100=500). By way of another example and not limitation, if the combination operator corresponds to the additive operator, then the first risk score associated with the update of the first element 214A and the second element 214B is calculated to be 60 (as 50+10=60).

At 306, risk mitigation techniques determination operation is executed. In the risk mitigation techniques determination operation, the system 202 determines the first set of risk mitigation techniques based on the calculated first risk score. In one exemplary embodiment, based on the first risk score calculated by the system 202, the system 202 determines the first set of risk mitigation techniques. For example, if the system 202 determines that the first risk score corresponding to the update of the first element 214A is 100, then the system 202 determines the first set of risk mitigation techniques associated with the determined first risk score of 100. By way of example and not limitation, the determined first set of risk mitigation techniques may include a creation of a backup of data associated with the application 212, a creation of a backup of the configuration associated with the application 212, generation of one or more snapshots associated with the application 212, execution of one or more preparatory checks, or creation of a set of canary applications associated with the application hosted on the container platform 208.

In another exemplary embodiment, the system 202 may retrieve the first set of risk mitigation techniques from the one or more data sources 210. The first set of risk mitigation techniques associated with the first risk score may be stored in the one or more data sources 210. In one example, if the calculated first risk score is in range of 1 to 10, then no risk mitigation techniques may be needed and the system 202 may update the application 212 without applying any risk mitigation technique. In another example, if the calculated first risk score is in the range of 10 to 50, then the first set of risk mitigation techniques may correspond to capturing the data associated with the application 212. The system 202 may capture the data associated with the application 212 before performing the update. In yet another example, if the calculated first risk score is in the range of 50 to 100, then the first set of risk mitigation techniques may correspond to capturing the data associated with the application 212 and capturing the configuration of the application 212. The system 202 may capture the data associated with the application 212 and capture the configuration of the application 212 before the update. In case failure occurs during the update process, the system 202 may roll back the application 212 by using the captured data and the captured configuration. In another example, if the calculated first risk score is more than 100, then the first set of risk mitigation techniques may correspond to capturing the data associated with the application 212, capturing the configuration of the application 212, and creating new replica and updating the created replica before performing the update on the live application 212.

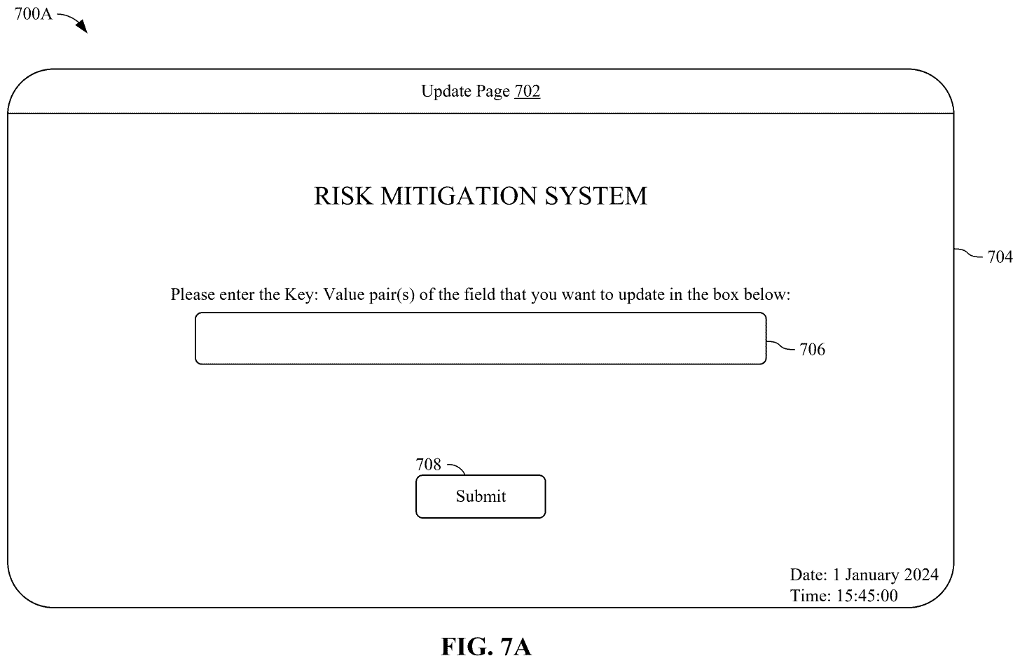

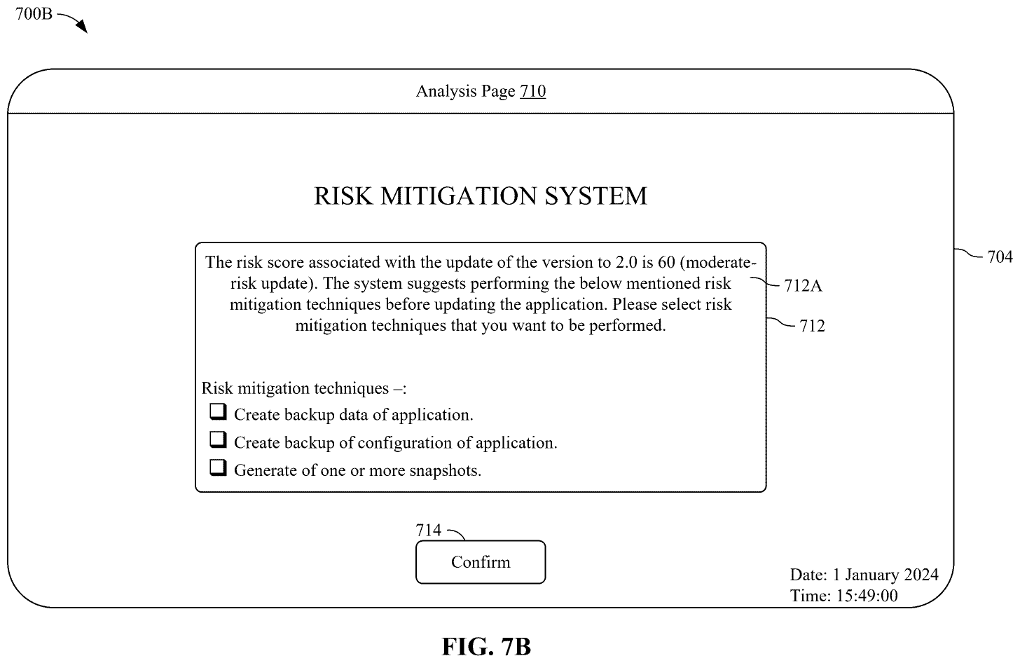

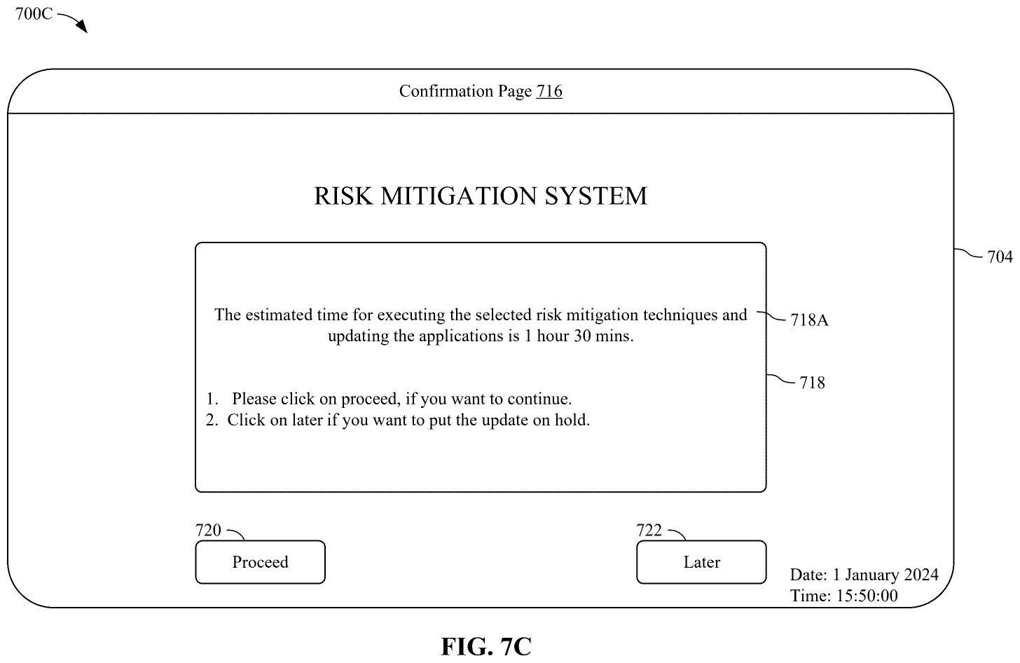

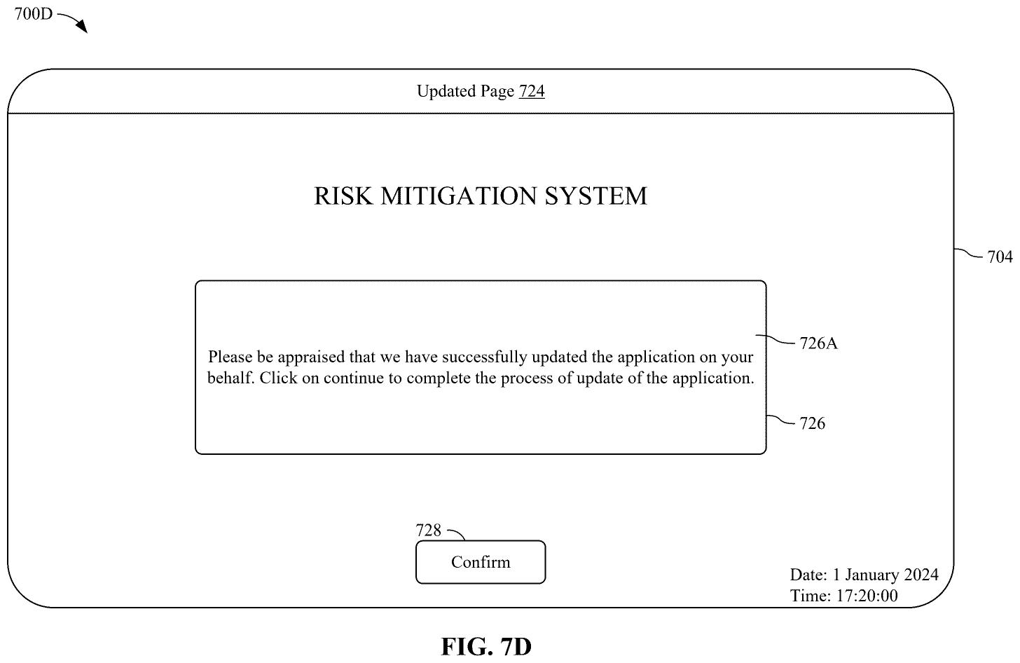

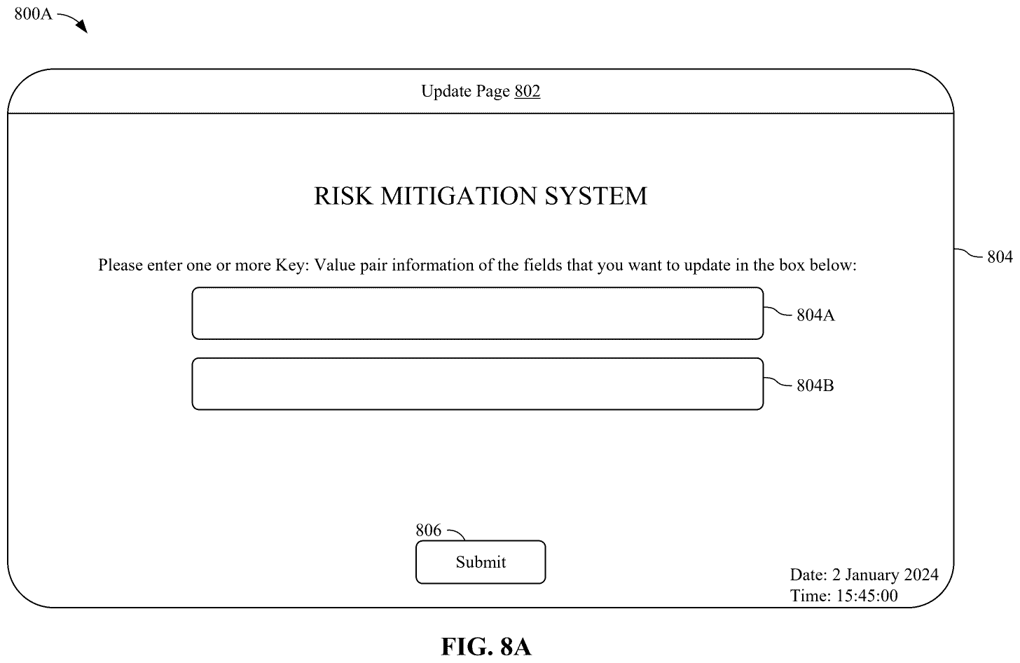

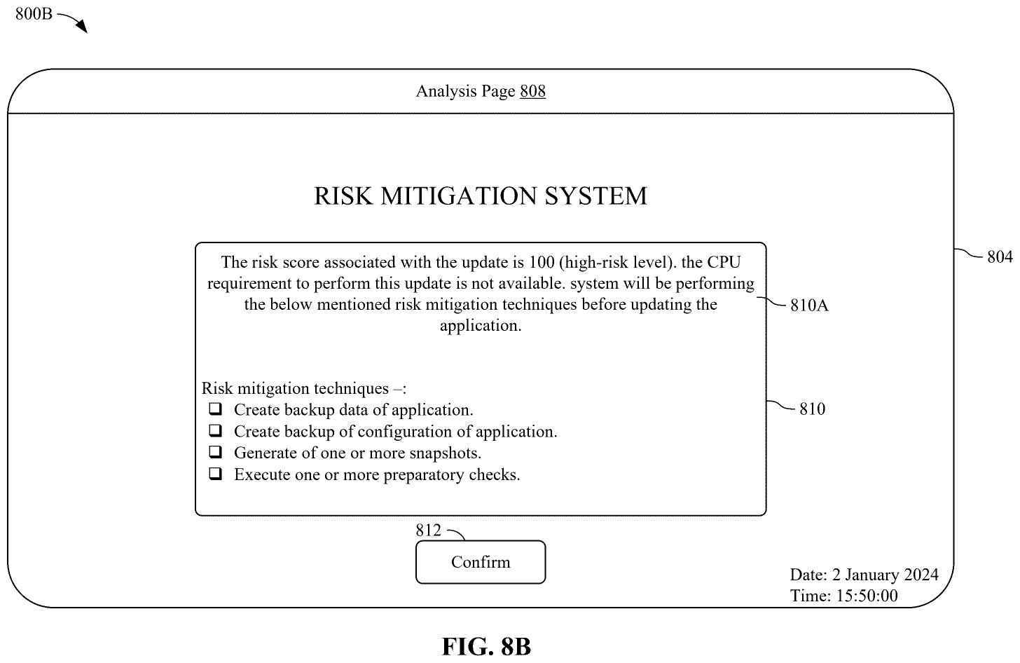

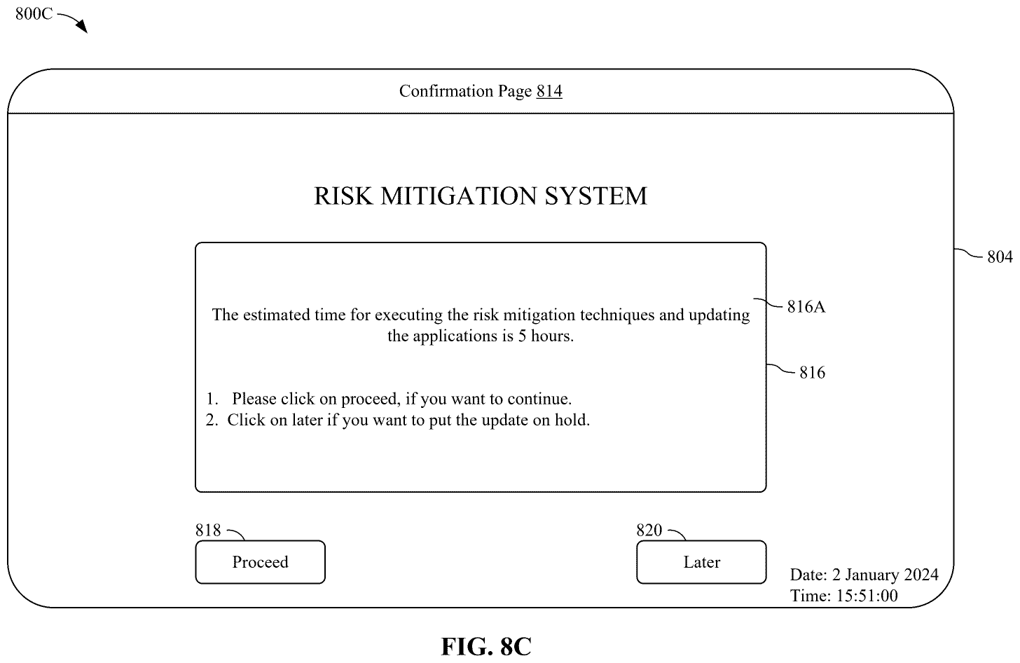

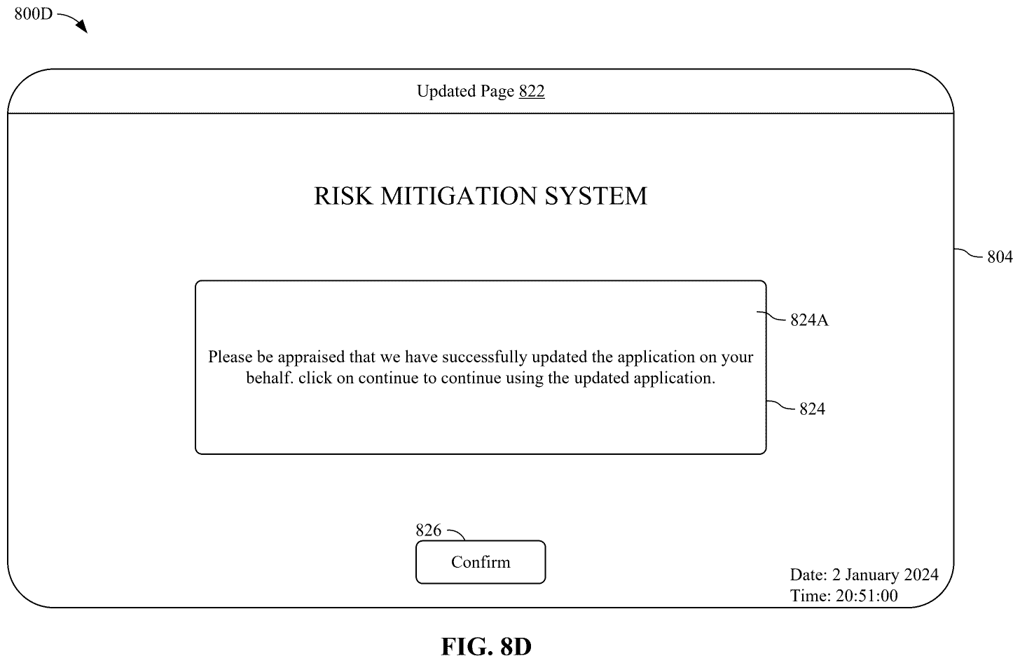

At 308, risk mitigation techniques output operation is executed. In the risk mitigation techniques output operation, the system 202 outputs the determined first set of risk mitigation techniques on the electronic device 204. Specifically, the system 202 displays the determined first set of risk mitigation techniques on the electronic device 204 so that the user 216 may be notified about the first set of risk mitigation techniques. Details about the output of the first set of risk mitigation techniques are provided, for example, in FIG. 7B and FIG. 8B.

At 310, a second input reception operation is executed. In the second input reception operation, the system 202 may receive the second input associated with a selection of one or more risk mitigation techniques of the determined first set of risk mitigation techniques that may be displayed on the electronic device 204. In an exemplary embodiment, the user 216 might not wish to proceed with execution of each of the determined first set of risk mitigation techniques as recommended by the system 202 due to cost constraints(s) and/or time constraint(s). Therefore, the system 202 may enable the user 216 to provide second input for selection of the one or more risk mitigation techniques of the determined first set of mitigation techniques. Details about the reception of the second input are provided, for example, in FIG. 7B and FIG. 8B.

At 312, risk mitigation technique execution operation is executed. In the risk mitigation technique execution operation, the system 202 executes the one or more risk mitigation techniques of the first set of risk mitigation techniques based on the received second input received from the user 216. By way of example and not limitation, if the user 216 provides the second input corresponding to the selection of the risk mitigation techniques such as taking the full backup of the current configuration of the application 212 and capturing the snapshots for each step of the update process, then the system 202 executes the corresponding selected risk mitigation techniques. In an embodiment, the system 202 may execute the one or more risk mitigation techniques before the update of the application 212 or during the update of the application 212. In another embodiment, the system 202 executes the one or more risk mitigation techniques during the update process of the application 212. Once the update process is complete, the control may pass to end.

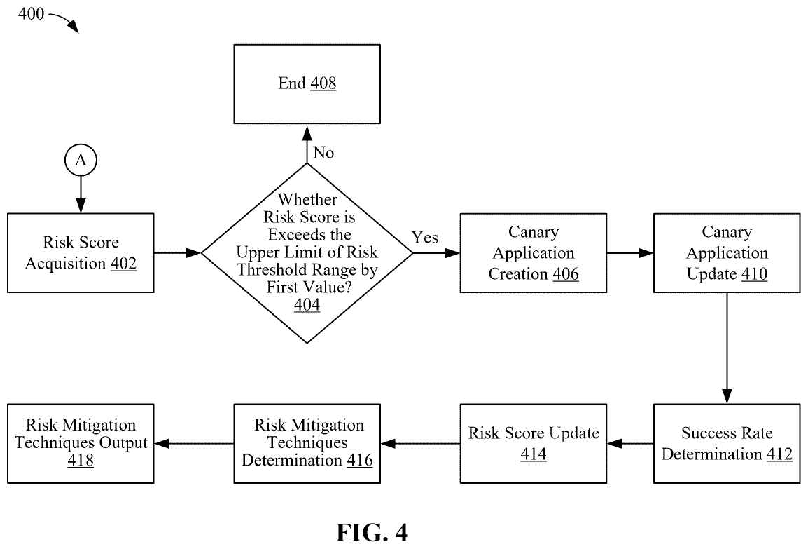

FIG. 4 is a diagram that illustrates exemplary operations for creation of canary application based on comparison of risk score with a threshold risk score, in accordance with an embodiment of the disclosure. FIG. 4 is explained in conjunction with elements from FIG. 1, FIG. 2, and FIG. 3. With reference to FIG. 4, there is shown a block diagram 400 that illustrates exemplary operations from 402 to 414, as described herein. The exemplary operations illustrated in the block diagram 400 may start at 402 and may be performed by any computing system, apparatus, or device, such as by the computer 102 of FIG. 1 or system 202 of FIG. 2. Although illustrated with discrete blocks, the exemplary operations associated with one or more blocks of the block diagram 400 may be divided into additional blocks, combined into fewer blocks, or eliminated, depending on the particular implementation.

In an embodiment, the system 202 receives the first input from the user 216 via the electronic device 204. The first input is associated with the update process of the application 212. Further, the system 202 calculates the first risk score based on the received first input. To further classify the update as a “low-risk update”, a “medium-risk update”, or a “high-risk update”, the system 202 may perform operations described from 402 to determine the set of risk mitigation techniques based on classification.

At 402, the risk score acquisition operation is executed. In the risk score acquisition operation, the system 202 acquires (or retrieves) the calculated first risk score. The calculated risk score may be associated with the update of the application 212 that may be hosted on the container platform 208. Details about the calculation of the risk score are provided, for example, at 304 in FIG. 3.

The system 202 may further compare the acquired risk score with a threshold risk score. In an exemplary embodiment, to classify the update and to further determine the first set of risk mitigation techniques, the system 202 may compare the calculated first risk score with the threshold risk score. The threshold risk score may correspond to a numerical value and may be retrieved from the one or more data sources 210. By way of example and not limitation, the threshold risk score may be 100, 200, 300, and the like. In an embodiment, the system 202 compares the first risk score with the threshold risk score to classify the update as “low-risk” updated or “high-risk” update and to further determine the first set of risk mitigation techniques.

In another embodiment, the threshold risk score corresponds to a threshold risk range. The threshold risk range may have an upper threshold risk limit and a lower threshold risk limit. In an exemplary embodiment, if the calculated first risk score is less than the lower limit of the threshold risk range, then the update may be classified as the low-risk update. If the calculated first risk score is greater than the lower limit of the threshold risk range and less than the upper limit of the threshold risk range, then the update may be classified as the medium-risk update. If the calculated first risk score is greater than the upper limit of the threshold risk range, then the update may be classified as the high-risk update.

For example, if the lower limit is 50, the upper limit is 100 and the calculated first risk score is 35, then the corresponding update may be classified as a “low-risk” update. As another example, if the lower limit is 50, the upper limit is 100, and the calculated first risk score is 75, then the corresponding update may be classified as a “medium-risk” update. As another example, if the lower limit is 50, the upper limit is 100, and the calculated first risk score is 248, then the corresponding update may be classified as a “high-risk” update.

In an embodiment, the system 202 may use a weighting approach to combine risk scores associated with one or more elements. For example, when the system 202 receives the request from the user 216 for the update of the version from “spec.version:1.0” to “spec.version: 2.0”, the system 202 retrieves the pre-determined risk score associated with the update of the “version” element of the application 212 from the one or more data sources 210. Further, the system 202 retrieves the score associated with updating the version of the application 212 from “spec.version:1.0” to “spec.version:2.0”. The score associated with updating the version of the application 212 from “spec.version:1.0” to “spec.version:2.0” may be calculated in a historical time period and stored in one or more data sources 210. For instance, the first the pre-determined risk score is 30 and the score associated with the update of the application from version 1.0 to version 2.0 is 40. The system 202 assigns a first weightage value (say “1”) to the pre-determined risk score of the first element 214A and a second weightage value (say “2”) to the score associated with the historical event. In an embodiment, the system 202 may calculate the first risk score associated with the update by combining the first weight and the second weight (1*30)+(2*40)=110.

At 404, the system 202 determines whether the first risk score is greater than the threshold risk score or not. In one exemplary embodiment, if the system 202 determines that the calculated first risk score is less than the threshold risk score, then the system 202 updates the application 212 without execution of the first set of mitigation techniques or with application of mandatory risk mitigation techniques that may be included in the first set of mitigation techniques. In case the calculated first risk score is lower than the threshold risk score, the system 202 may update the application 212 without disrupting the running application 212. As an example, if the system 202 determines that the requested update by the user 216 is low-risk update (for example, the first risk score is 10), then the system 202 determines that no risk mitigation techniques need to be executed before the update of the application 212 or during the update of the application 212. The system 202 updates the application 212 quickly and efficiently.

In other exemplary scenario, if the system 202 determines that the requested update by the user 216 is the “medium-risk” update, then the system 202 determines and performs the one or more risk mitigation techniques of the first set of risk mitigation techniques associated with the medium-risk update of the application 212. The one or more risk mitigation techniques of the first set of risk mitigation techniques associated with the “medium-risk” update may be for example, but not limited to, capturing of the data associated with the application 212. The system 202 performs the risk mitigation technique by capturing the data associated with the application 212 before updating the application 212 to mitigate the risk of data loss upon the update of the application 212. In an exemplary embodiment, the system 202 captures the data associated with the application 212 and stores the captured data on the server 206. In another exemplary embodiment, the system 202 captures the data associated with the application 212 and stores it the one or more data sources 210. Such data may be used for rolling back the update of the application 212, in case of a failure of the update of the application.

In another exemplary scenario, if the system 202 determines that the requested update by the user 216 is the “high-risk” update, then the system 202 determines and performs the one or more risk mitigation techniques of the first set of risk mitigation techniques associated with the high-risk update of the application 212. The one or more risk mitigation techniques of the first set of risk mitigation techniques associated with the high-risk update are, for example, but not limited to, capturing full backup of the data, and capturing all the configuration and settings associated with the application 212. The system 202 performs the risk mitigation technique by capturing full backup of the data and capturing all the configuration and settings associated with the application 212 before updating the application 212 to mitigate the risk of failure of update of the application 212. In an exemplary embodiment, the system 202 captures at least the full backup of the data associated with the application 212 and the configurations and settings of the application 212 and stores it the server 206. In another exemplary embodiment, the system 202 captures at least the full backup of the data associated with the application 212 and the configurations and settings of the application 212 and stores it the one or more data sources 210.

In yet another exemplary scenario, if the calculated first risk exceeds the upper limit of the threshold range by a first value (say 1000 or 5000), then the system 202 may classify such update as a “very high-risk” update. In such a case, the system 202 may determine that the risk is very high and there might be a need to establish a more accurate level of risk in the precise circumstances of the application 212 and requested update (or change). To accommodate such a change, the system 202 creates a set of canary applications associated with the application 212 hosted on the container platform 208 as described at 406. Otherwise, if the calculated first risk does not exceed the upper limit of the threshold range by the first value, then the control may pass to the risk mitigation techniques determination operation at 306 or to end at 408.

At 406, a canary applications creation operation is executed. In the canary application creation operation, the system 202 may create a set of canary applications that may be associated with the application 212. Each canary application of the set of canary applications may correspond to the instances of the application 212. In other words, each canary application of the set of canary applications may be a replica of the application 212. Specifically, configuration of each canary application of the set of canary applications may be same as the configuration of the application 212 hosted on the container platform 208. Furthermore, each canary application of the set of canary applications may be loaded with same data as that the application 212 hosted on the container platform 208. Such set of canary applications may be created to establish the more accurate level of risk in the precise circumstances of the application 212 and requested update (or change).

At 410, a canary application update operation is executed. In the canary application update operation, the system 202 updates each canary application of the created set of canary application as requested by the user 216 in the first input. In an exemplary embodiment, if the system 202 received the first input from the user 216, where the first input corresponds to the update of the first element 214A and the second element 214B, then the system 202 updates the first element 214A and the second element 214B of each of the created set of canary application.

At 412, a success rate determination operation is executed. In the success rate determination operation, the system 202 determines a success rate (also referred to as a second result) indicative of one of a success or a failure associated with the update of each canary application of the created set of canary application. In an exemplary embodiment, the system 202 creates 200 canary applications and updates each canary applications based on the updates included in the received input. The system 202 further determines the second result indicative of one of a success or a failure associated with the update of each of the 200 canary application of the created set of canary applications. The system 202 may determine a count of canary applications that may be updated successfully. Based on the determined count, the system 202 determines the success rate. By way of example, if 100 applications have been updated successfully, then the success rate may be 50%. As another example, if only 20 canary applications, out of 200 canary applications, are updated successfully, then the success rate may be 10%.

At 414, a risk score update operation is executed. In the risk score update operation, the system 202 may update the first risk score associated with the update of the application 212 based on the determined success rate by calculating the first risk score based on the determination of the second result.

In an embodiment, the system 202 associates a first weightage value to the first risk score (acquired at 402), and a second weightage value to the success rate. Based on a combination of the first weightage value, the first risk score, the second weightage value, and the success rate, the system 202 may update the first risk score. By way of example and not limitation, the first weightage value may be “1”, and the first weightage value may be “3”.

At 416, a risk mitigation techniques determination operation is executed. In the risk mitigation techniques determination operation, the system 202 determines a second set of mitigation techniques that may be associated with the updated first risk score. Similar to the first set of mitigation techniques, the second set of mitigation techniques may include at least one of the creation of the backup of data associated with the application 212, the creation of the backup of the configuration associated with the application 212, the generation of one or more snapshots associated with the application 212, or the execution of one or more preparatory checks. In an embodiment, a mapping of the risk scores and corresponding mitigation techniques may be stored in the one or more data sources 210. In such case, the system 202 may retrieve the second set of mitigation techniques from the one or more data sources 210. Such a mapping may be created by the development and support team of the container platform 208 and/or application 212. Details about the mitigation techniques are provided, for example, in FIG. 3.

At 418, a risk mitigation techniques output operation is executed. In the risk mitigation techniques output operation, the system 202 outputs the determined second set of mitigation techniques. Specifically, the system 202 outputs the second set of mitigation techniques on the electronic device 204 associated with the user 216. Details about the output of the risk mitigation techniques are provided, for example, in FIG. 3.

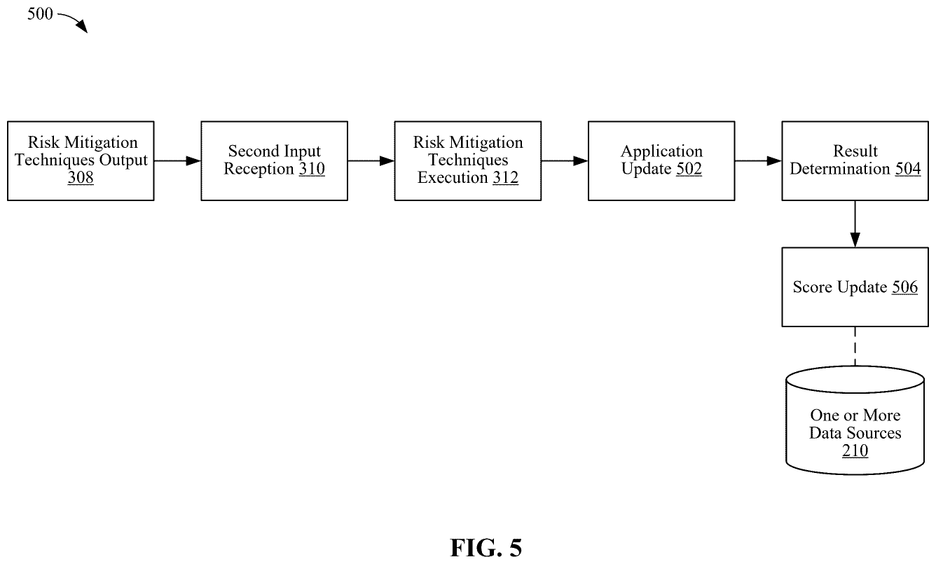

FIG. 5 is a diagram that illustrates exemplary operations to update risk score, in accordance with an embodiment of the disclosure. FIG. 5 is explained in conjunction with elements from FIG. 1, FIG. 2, FIG. 3, and FIG. 4. With reference to FIG. 5, there is shown a block diagram 500. The exemplary operations illustrated in the block diagram 500 may be performed by any computing system, apparatus, or device, such as by the computer 102 of FIG. 1 or system 202 of FIG. 2. Although illustrated with discrete blocks, the exemplary operations associated with one or more blocks of the block diagram 500 may be divided into additional blocks, combined into fewer blocks, or eliminated, depending on the particular implementation.

In an embodiment, the system 202 outputs the first set of risk mitigation techniques on the electronic device 204. Further, the system 202 receives the second input associated with the selection of one or more risk mitigation techniques of the determined first ser of risk mitigation techniques from the user 216. The system 202 further executes the selected one or more risk mitigation techniques of the first set of risk mitigation techniques based on the second input received from the user 216. Details about outputting of risk mitigation techniques output are provided, for example, at 308 in FIG. 3. Details about the reception of the second input are provided, for example, at 310 in FIG. 3, and details about the execution of the risk mitigation techniques are provided, for example, at 312 in FIG. 3.

At 502, application update operation is executed. In an embodiment, the system 202 executes the application update operation. In the application update operation, the system 202 updates the application 212 after the execution of the one or more risk mitigation techniques of the first set of risk mitigation techniques. As an example, the first set of risk mitigation techniques that may be displayed on the electronic device 204 may include at least one of the creation of the backup of the data associated with the application 212, the creation of the backup of the configuration associated with the application 212, generation of the one or more snapshots associated with the application 212, execution of the one or more preparatory checks and the creation of the set of canary applications associated with the application 212 hosted on the container platform 208.

Further, the system 202 receives the second input from the electronic device 204 associated with user 216. The second input may correspond to the selection of one or more risk mitigation techniques from the first set of mitigation techniques. The one or more risk mitigation techniques selected by the user 216 correspond to the creation of the backup of the data associated with the application 212, and the creation of the backup of the configuration associated with the application 212. The system 202 further executes the selected one or more risk mitigation techniques selected by the user 216 before updating the application 212.

At 504, a result determination operation is executed. In the result determination operation, the system 202 determines a first result after the execution of the selected one or more risk mitigation techniques selected by the user 216. The first result may be indicative of one of the success or the failure associated with the update of the application 212 after the execution of the selected one or more risk mitigation techniques. In one exemplary embodiment, if the update process of the application 212 resulted in success, the first result is indicative of the success of the update of the application 212 after the execution of the selected one or more risk mitigation techniques. In another exemplary embodiment, if the update process of the application 212 resulted in failure, the first result is indicative of the failure of the update of the application 212 after the execution of the selected one or more risk mitigation techniques.

At 506, one or more score update operations are executed. In the one or more score update operation, the system 202 updates the one or more scores based on the determined first result. In an exemplary embodiment, if the first result is indicative of the success of the update of the application 212, then the system 202 may not update the score associated with the one or more elements. In an exemplary embodiment, if the first result is indicative of the success of the update of the application 212, then the system 202 may decrease the score associated with the one or more elements. In an alternative embodiment, if the first result is indicative of the failure of the update of the application 212, then the system 202 may increase the score associated with the one or more elements. Such updated scores may be stored in the one or more data sources 210 and may be used to calculate risk scores in the future.

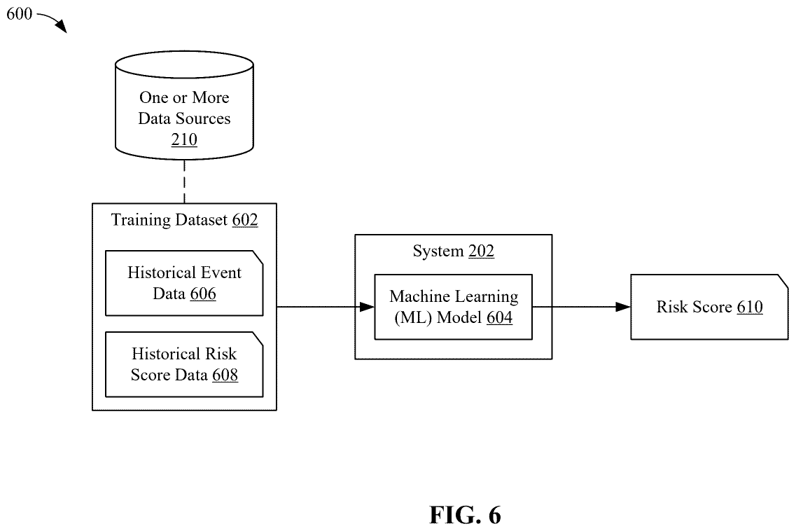

FIG. 6 is a diagram depicting training of first ML model for the determination of risk mitigation techniques associated with updating of applications hosted on container platforms, in accordance with an embodiment of the disclosure. With reference to FIG. 6, there is shown a diagram 600. The diagram 600 includes a training dataset 602, a machine learning model 604, historical event data 606, historical risk score data 608, and risk score 610. The historical event data 606 is associated with historical one or more updating events and historical risk score data 608 is associated with the historical one or more updating events.

The training dataset 602 may be required for developing the ML model 604 capable of making accurate predictions. The training dataset 602 may input-output pairs where the input is the data fed into the ML model 604 and the output may be the expected result of the ML model 604. With reference to FIG. 6, the input may correspond to the historical event data 606 and the output may correspond to the historical risk score data 608. The system 202 may be further train the ML model 604 based on the training dataset 602. The primary goal during the training of the ML model 604 is for the ML model 604 to learn the underlying patterns and relationships within the data so it can generalize well to new, unseen data.

In an embodiment, the quality of the training dataset 602 may be crucial. The training dataset 602 must be representative of the problem domain to ensure the ML model 604 may handle real-world scenarios effectively. This may involve ensuring the training dataset 602 is diverse and includes a wide range of examples to cover different variations and edge cases. Additionally, the training of the ML model 604 may be dependent on a size of the training dataset 602. Usually, larger datasets typically provide more information for the ML model 604 to learn from, thereby leading to better performance.

In an embodiment, the system 202 retrieves the risk scores associated with plurality of historical update events from the one or more data sources 210 and creates the training dataset 602. The training dataset 602 includes historical event data 606. In an exemplary embodiment, the historical event data 606 corresponds to data about the update events that may be performed on the application 212 hosted on the container platform 208. At a first timestamp, the system 202 receives an input associated with the update of a first element and a second element associated with the application 212. The first element 214A corresponds to the “spec.version”, and the second element 214B corresponds to the “spec.storage.type”. Further, the data about the update of the first element and the second element is stored in the historical event data 606. The first timestamp may occur in historical time period. The historical time period may be, for example, but not limited to, 1 day before current day of update process, 1 week before the current day of the update process, 1 year before the current day of the update process. The system 202 may further calculate the risk score associated with the update of the first element and the second element. The calculated risk score may be stored as the historical risk score data 608 associated with the historical update events.

In an embodiment, the system 202 trains the ML model 604 on the training dataset 602 for the calculation of the risk score 610 and further for the determination of the risk mitigation techniques for updating application 212 hosted on the container platforms 208. The process of calculating the risk score 610 for the update of the application 212 hosted on the container platform 208 may be effectively managed based on the application of the ML model 604 trained on the training dataset 602 including the historical event data 606 and the historical risk score data 608.

In an additional embodiment, the historical event data 606 can be created using simulation technologies known in the art. Specifically, the system 202 may create the set of canary applications and updates each of the set of canary applications. For example, the system 202 performs one or more updates associated with the one or more elements of the plurality of elements 214 in each of the set of canary applications to calculate the first risk score associated with the corresponding update. The system 202 further stores the calculated first risk score in the one or more data sources 210. While creating the training dataset 602, the system 202 retrieves the calculated first risk score associated with one or more updates of each of the set of created canary applications. The system 202 further determines the set of risk mitigation techniques based on the calculated first risk score and stores the determined first set of risk mitigation techniques in the historical event data 606 of the training dataset 602. The training dataset 602 is further used to train the ML model 604.

The ML model 604 associated with the system 202 identifies patterns and correlations that predict the likelihood of issues that occur during the update of the application 212 hosted on the container platform 208 based on the event data associated with the update event. Such data-driven approach allows for more accurate and automated assessment of risk, reducing reliance on manual oversight and minimizing human error.

In an embodiment, for the prediction of the risk score 610 to determine the risk mitigation techniques for updating applications hosted on the container platforms, the system 202 utilizes the ML model 604 trained on the training dataset 602. The system 202 can implement machine learning techniques for the prediction of the risk score 610, the machine learning techniques can be, for example, but not limited to, a logistic regression, a random forest, a neural network, a support vector machine, K-Nearest Neighbours (KNN).

In operation, the system 202 receives the first input associated with the update of one or more elements of the plurality of elements 214 associated with the configuration of the application 212 hosted on the container platform 208. In an exemplary embodiment, the first input corresponds to update of the first element 214A of the application 212. Further, the system 202 calculates the first risk score associated with the update of first element 214A of the plurality of elements 214 based on the application of the ML model 604 on the received first input. The first ML model is trained on the training dataset 602 that includes the historical risk score data 608 and the historical event data 606.

Further, based on the calculated first risk score, the system 202 determines the first set of risk mitigation techniques. The system 202 further outputs the determined first set of risk mitigation techniques on the electronic device 204. Further, the system 202 executes the first set of risk mitigation techniques before the update of the application 212 or during the update of the application 212 to mitigate risks associated with the update of the application 212.

It may be noted that the ML model 604A, as shown in FIG. 6, is trained to calculate the risk score. However, the disclosure may not be restricted to training the ML model solely for calculating the risk score. The ML model 604 may be trained to determine the set of risk mitigation techniques based on the received input(s). However, we have omitted the description for the training of the ML model 604 for determination of the set of risk mitigation techniques have been omitted for the sake of brevity.

FIG. 7A, FIG. 7B, FIG. 7C, and FIG. 7D are exemplary diagrams 700A, 700B,700C, and 700D that collectively depict a user interface associated with the operations for determination of risk mitigation techniques for updating applications hosted on the container platforms, in accordance with an embodiment of the disclosure. FIG. 7A, FIG. 7B, FIG. 7C, and FIG. 7D are explained in conjunction with FIG. 1, FIG. 2, FIG. 3, FIG. 4, FIG. 5, and FIG. 6. With reference to FIG. 7A, FIG. 7B, FIG. 7C, and FIG. 7D, there is shown an electronic device 704. The electronic device 704 may be an exemplary embodiment of the electronic device 204 of FIG. 2.

With reference to FIG. 7A, the system 202 receives the first input from the user 216 via the electronic device 704. The electronic device 204 includes the display that render an update page 702 to the user 216. The update page 702 may be rendered on a user interface (UI) of the electronic device 204. In an embodiment, the update page 702 displays a prompt “Please enter the Key:Value pair(s) of the field that you want to update in the box below:”. In an embodiment, the system 202 receives the first input from the user 216 as the user 216 enters the “key: value” pair for the first element 214A in a first UI element 706 that may correspond to a textbox. In an exemplary embodiment, the first input corresponds to “spec.version:2.0”.

Further, upon providing the first input, the user 216 may select (or clicks on) a second UI element 708 that may correspond to a button and may be labelled as “Submit”. The update page 702 further displays current data and current time. In one example, the current date corresponds to “1 Jan. 2024”, and current time corresponds to “15:45:00”.

Based on the selection of the second UI element 708, the electronic device 204 displays an analysis page 710 as shown on FIG. 7B. The system 202 calculates the first risk score associated with the update of the first element 214A provided as the first input by the user 216 and displays it on the analysis page 710. The analysis page 710 comprises of a third UI element 712 that may be a textbox and may display a prompt 712A that corresponds to “The risk score associated with the update of the version to 2.0 is 60 (moderate-risk update). The system suggests performing the below mentioned risk mitigation techniques before updating the application. Please select risk mitigation techniques that you want to be performed.”. Further, the system 202 outputs the determined first set of risk mitigation techniques on the prompt 712A in as a check box. In an exemplary embodiment, as shown in FIG. 7B, the system 202 may perform at least two risk mitigation techniques of the three risk mitigation techniques suggested by the system 202. Such mitigation techniques that may be performed by the system 202 may be selected by default and may be executed by the system 102 before the update of the application 212 or during the update of the application 212. Further, the user 216 may have a choice to select the third risk mitigation technique (i.e. “Generate one or more snapshots”) if the user 216 wants the system 202 to perform all the three risk mitigation techniques. The system 202 further receives the second input associated with the selection of the one or more risk mitigation techniques of the first set of risk mitigation techniques. Once selected, the user 216 may select a fourth UI element 714 that may be a button and may be labelled as “Confirm”.

In an alternative embodiment, the user 216 may be able to unselect the mitigation techniques that may be selected by default. In such cases, the system 202 may not execute the mitigation techniques that may be unselected by the user 216. The system 202 further executes all other mitigation techniques that may be selected either by the system 202 as default mitigation techniques or by the user 216.

In an embodiment, once the user 216 selects the one or more risk mitigation techniques, the system 202 displays a confirmation page 716 on the display of the electronic device. The confirmation page 716 may include a fifth UI element 718 that may be a textbox and may display a prompt 718A that may correspond to “The estimated time for executing the selected risk mitigation techniques and updating the applications is 1 hour 30 mins.
1. Please click on proceed, if you want to continue.
2. Click on later if you want to put the update on hold.
3. Click on avoid, if you don't want to proceed with the update.”

In one exemplary embodiment, the user 216 can select a sixth UI element 720 that may be labelled as “Proceed” if the user 216 can wait for estimated time. In another exemplary embodiment, the user 216 can select a seventh UI element 722 that may be a button labelled as “Later” if the user 216 wants to put the update of the application 212 on hold. In yet another exemplary embodiment, the user 216 can select an eighth UI element 724 that may be a button labelled as “Avoid” if the user 216 does not wish to proceed with the update of the application 212.

In an embodiment, if the user 216 proceeds with the update process of the application 212, the system 202 displays an updated page 726 on the electronic device 704. The updated page 726 includes a ninth UI element 728 that may be a textbox and may display a prompt 728A that corresponds to “Please be appraised that we have successfully updated the application on your behalf Click on continue to complete the process of update of the application.” The updated page 726 is indicative of that the application 212 is successfully updated. The user 216 can select a tenth UI element 730 that may be a button and may be labelled as “Continue”. Based on the selection of the tenth UI element 730, the user 216 may wish to continue using the updated application 212.

FIG. 8A, FIG. 8B, FIG. 8C, and FIG. 8D are exemplary diagrams 800A, 800B, 800C, and 800D that collectively depict user interface associated with the operations for determination of risk mitigation techniques for updating applications hosted on the container platforms, in accordance with an embodiment of the disclosure. FIG. 8A, FIG. 8B, FIG. 8C, and FIG. 8D are explained in conjunction with FIG. 1, FIG. 2, FIG. 3, FIG. 4, FIG. 5, and FIG. 6, FIG. 7A, FIG. 7B, FIG. 7C, and FIG. 7D. With reference to FIG. 8A, FIG. 8B, FIG. 8C, and FIG. 8D, there is shown an electronic device 804. The electronic device 804 may be an exemplary embodiment of the electronic device 204 of FIG. 2

With reference to FIG. 8A, the system 202 receives the first input from the user 216 via the electronic device 804. The electronic device 804 includes the display that render an update page 802 to the user 216. The update page 802 may be rendered on a user interface (UI) of the electronic device 804. In an embodiment, the update page 802 displays a prompt “Please enter one or more Key: Value Pair(s) of the fields that you want to update in the box below”. In an embodiment, the system 202 receives the first input from the user 216 as the user 216 enters the “key:value” pair for the first element 214A and the second element 214B in a first UI element 804A and a second UI element 804B respectively. In an embodiment, the first UI element 804A and the second UI element 804B may correspond to a textbox. In an exemplary embodiment, the first input corresponds to “spec. version: 2.0” and “spec.storage.type: ephemeral”.

Further, upon providing the first input, the user 216 may select (or clicks on) a second UI element 806 that may correspond to a button and may be labelled as “Submit”. The update page 802 further displays current data and current time. In one example, the current date corresponds to “2 Jan. 2024”, and current time corresponds to “15:45:00”.

Based on the selection of the second UI element 806, the electronic device 204 displays the analysis page 808 as shown on FIG. 8B. The system 202 calculates the first risk score associated with the update of the first element 214A and the second element 214B provided as the first input by the user 216 and displays it on the analysis page 808. The analysis page comprises of a third UI element 810 that may be a textbox and may display a prompt 810A that corresponds to “The risk score associated with the update of the version to 2.0 and storage type to ephemeral is 100 (high-risk update). The CPU requirement to perform this update is not available. The system suggests performing the below mentioned risk mitigation techniques before updating the application. Please select risk mitigation techniques that you want to be performed”. Further, the system 202 outputs the determined first set of risk mitigation techniques on the prompt 810A as a check box. In an exemplary embodiment, as shown in FIG. 8B, the system 202 will perform two risk mitigation techniques of the four risk mitigation techniques suggested by the system 202. Further, the user 216 has the choice to select the one or more risk mitigation techniques (i.e. “Generate one or more snapshots” and “Execute one or more preparatory checks”) if the user 216 wants the system 202 to perform all the suggested risk mitigation techniques.

The system 202 further receives the second input associated with the selection of the one or more risk mitigation techniques of the first set of risk mitigation techniques. Once selected, the user 216 may select a fourth UI element 812 that may be a button and may be labelled as “Confirm”.

In an embodiment, once the user 216 selects the one or more risk mitigation techniques, the system 202 displays a confirmation page 814 on the display of the electronic device 804. The confirmation page 814 may include a fifth UI element 816 that may be a textbox and may display a prompt 816A that may correspond to “The estimated time for executing the risk mitigation techniques and updating the applications is 5 hours.
1. Please click on proceed, if you want to continue.
2. Click on later if you want to put the update on hold.
3. Click on avoid, if you don't want to proceed with the update.”

In one exemplary embodiment, the user 216 can select a sixth UI element 818 that may be labelled as “Proceed” if the user 216 can wait for estimated time. In another exemplary embodiment, the user 216 can select a seventh UI element 820 that may be a button labelled as “Later” if the user 216 wants to put the update of the application 212 on hold. In yet another exemplary embodiment, the user 216 can select an eighth UI element 822 if the user does not wish to proceed with the update of the application 212.

In an embodiment, if the user 216 proceeds with the update process of the application 212, the system 202 displays an updated page 824 on the electronic device 804. In an exemplary embodiment, the system 202 performs one or more risk mitigation techniques of the first set of risk mitigation techniques during the update process of the application 212. For example, the system 202 may perform the risk mitigation technique associated with the backup of the application 212 between key steps of the update. In a scenario, when the update of the application 212 is taking place, the system 202 takes backup of the application 212 at various intervals such as when 10% of the update is complete, when 20% of the update is complete, when 30% of the update is complete, when 50% of the update is complete, and the like. In case a failure occurs at a specific interval, the system 202 analyses the latest backed up data associated with the application 212 to determine the cause of the failure.

The updated page 824 includes a ninth UI element 826 that may be a textbox and may display a prompt 826A that corresponds to “Please be appraised that we have successfully updated the application on your behalf Click on continue to complete the process of update of the application.” The updated page 824 is indicative of that the application 212 is successfully updated. The user 216 can select a tenth UI element 828 that may be a button and may be labelled as “Continue”. Based on the selection of the tenth UI element 828, the user 216 may wish to continue using the updated application 212.

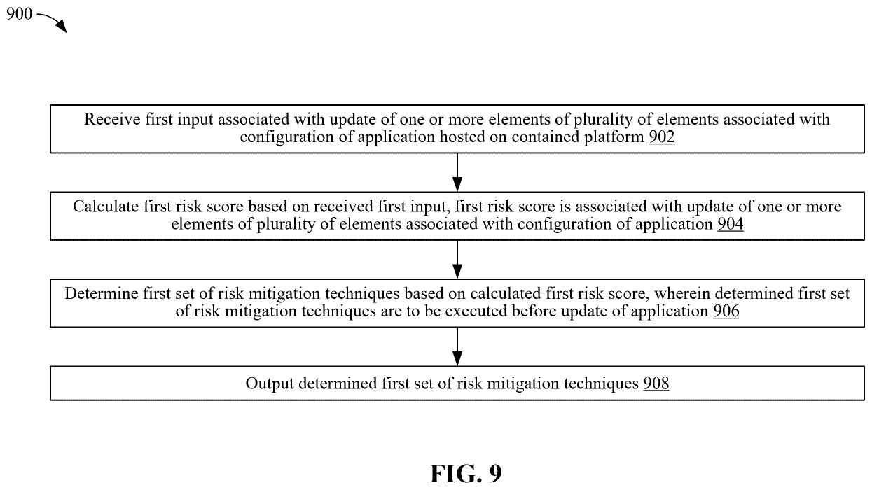

FIG. 9 is a flowchart that illustrates an exemplary method for determination of risk mitigation techniques for updating applications hosted on the container platforms, in accordance with an embodiment of the disclosure. FIG. 9 is explained in conjunction with elements from FIG. 1, FIG. 2, FIG. 3, FIG. 4, FIG. 5, FIG. 6, FIG. 7A, FIG. 7B, FIG. 7C, FIG. 7D, FIG. 8A, FIG. 8B, FIG. 8C, and FIG. 8D. With reference to FIG. 9, there is shown a flowchart 900. The operations of the exemplary method may be executed by any computing system, for example, by the computer 102 of FIG. 1 or the system 202 of FIG. 2. The operations of the flowchart 900 may start at 902.

At 902, the first input associated with the update of the one or more elements of plurality of elements 214 associated with the configuration of the application 212 hosted on container platform 208 is received. In an embodiment, the system 202 receives the first input associated with the update of the one or more elements of plurality of elements 214 associated with the configuration of the application 212 hosted on container platform 208. Details about the reception of the first input are provided, for example, in FIG. 2, FIG. 3, FIG. 7A, and FIG. 8A.

At 904, the first risk score based on the received first input is calculated. The first risk score is associated with the update of the one or more elements of plurality of elements 214 associated with configuration of the application 212. In an embodiment, the system 202 calculates the first risk score based on the received first input is calculated. The first risk score is associated with the update of the one or more elements of plurality of elements 214 associated with configuration of the application 212. Details about the calculation of the first risk score are provided, for example, in FIG. 3, and FIG. 4.

At 906, the first set of risk mitigation techniques based on the calculated first risk score is determined. The determined first set of risk mitigation techniques are to be executed before the update of application 212. In an embodiment, the system 202 determines the first set of risk mitigation techniques based on the calculated first risk score. The determined first set of risk mitigation techniques are to be executed before the update of application 212. Details about the determination of the first set of risk mitigation techniques are provided, for example, in FIG. 3, and FIG. 4.

At 908, the determined first set of risk mitigation techniques is outputted. In an embodiment, the system 202 outputs the determined first set of risk mitigation techniques. Details about the output of the first set of risk mitigation techniques are provided, for example, in FIG. 7B, and FIG. 8B.

In an embodiment, the system 202 may correspond to a Kubernetes® operator that may perform all the updates of the application 212 requested by the user 216. The system 202 may perform all the updates while mitigating any risk associated with the update of the application 212. The system 202 may determine the risk associated with the update, take appropriate level of risk mitigation, and report back the status of the update to the user 216. Further, in case of any failure occurring during the update, the system 202 may take steps to roll back or restore the application 212 automatically.

Various embodiments of the disclosure may provide a non-transitory computer readable medium and/or storage medium having stored thereon, instructions executable by a machine and/or a computer to operate a system (e.g., the system 202) for determination of risk mitigation techniques for updating applications hosted on container platforms. The instructions may cause the machine and/or computer to receive a first input associated with an update of one or more elements of a plurality of elements associated with a configuration of an application hosted on a container platform. The program instructions further cause the system to calculate a first risk score based on the received first input, the first risk score is associated with the update of the one or more elements of the plurality of elements associated with the configuration of the application. The program instructions further cause the system to determine a first set of risk mitigation techniques based on the calculated first risk score. The determined first set of risk mitigation techniques are to be executed before an update of the application. The program instructions further cause the system to output the determined first set of risk mitigation techniques.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer, a first input associated with an update of one or more elements of a plurality of elements associated with a configuration of an application hosted on a container platform;
calculating, by the computer, a first risk score based on the received first input, the first risk score is associated with the update of the one or more elements of the plurality of elements associated with the configuration of the application;
determining, by the computer, a first set of risk mitigation techniques based on the calculated first risk score, wherein the determined first set of risk mitigation techniques are to be executed before updating the application; and
outputting, by the computer, the determined first set of risk mitigation techniques.

2. The computer-implemented method of claim 1, further comprising:
retrieving, by the computer, one or more scores associated with the one or more elements based on the received first input, wherein the one or more scores are retrieved from one or more data sources;
determining, by the computer, a combination operator based on the received first input; and
calculating, by the computer, the first risk score based on the retrieved one or more scores and the determined combination operator.

3. The computer-implemented method of claim 2, wherein the calculation of the first risk score is based on an application of the determined combination operator on the retrieved one or more scores, and wherein the determined combination operator corresponds to one of an additive operator, a multiplier operator, or an exponential operator.

4. The computer-implemented method of claim 2, further comprising:
determining, by the computer, a first value of a first element of the one or more elements based on the received first input;
determining, by the computer, a second value of the first element of the one or more elements based on the received first input, wherein the received first input comprises the second value; and
retrieving, by the computer, a first score of the one or more scores associated with the first element based on the determined first value and the determined second value, wherein the first score associated with the update of the first element from the first value to the second value is stored in the one or more data sources.

5. The computer-implemented method of claim 2, further comprising:
identifying, by the computer, an absence of a score associated with at least one element of the plurality of elements associated with the configuration of the application hosted on the container platform; and
assigning, by the computer, a default score with each of the at least one element based on the identification.

6. The computer-implemented method of claim 2, further comprising:
executing, by the computer, each of the first set of risk mitigation techniques before the update of the application;
updating, by the computer, the application based on the execution of each of the first set of risk mitigation techniques;
determining, by the computer, a first result indicative of one of a success or a failure associated with the update of the application; and
updating, by the computer, the one or more scores based on the determined first result.

7. The computer-implemented method of claim 1, further comprising:
comparing, by the computer, the calculated first risk score with a threshold risk score; and
determining, by the computer, the first set of risk mitigation techniques based on the comparison.

8. The computer-implemented method of claim 1, further comprising:
receiving, by the computer, a second input associated with a selection of one or more risk mitigation techniques of the determined first set of risk mitigation techniques; and
executing, by the computer, the selected one or more risk mitigation techniques based on the received second input, wherein the selected one or more risk mitigation techniques are to be executed before updating of the application.

9. The computer-implemented method of claim 1, wherein the first set of risk mitigation techniques comprises at least one of a creation of a backup of data associated with the application, a creation of a backup of the configuration associated with the application, generation of one or more snapshots associated with the application, execution of one or more preparatory checks, or creation of a set of canary applications associated with the application hosted on the container platform.

10. The computer-implemented method of claim 9, further comprising:
creating, by the computer, the set of canary applications based on a determination that the calculated first risk score is greater than a threshold risk score, wherein the set of canary applications are associated with the application hosted on the container platform;
updating, by the computer, each canary application of the created set of canary applications based on the received first input;
determining, by the computer, a second result indicative of one of a success or a failure associated with the update of each canary application of the created set of canary applications; and
calculating, by the computer, the first risk score based on the determination of the second result.

11. The method of claim 10, wherein the configuration of each canary application of the created set of canary applications is same as the configuration of the application hosted on the container platform.

12. A system, comprising:
a processor set configured to:
receive a first input associated with an update of one or more elements of a plurality of elements associated with a configuration of an application hosted on a container platform;
calculate a first risk score based on the received first input, the first risk score is associated with the update of the one or more elements of the plurality of elements associated with the configuration of the application;
determine a first set of risk mitigation techniques based on the calculated first risk score, wherein the determined first set of risk mitigation techniques are to be executed before an update of the application; and
output the determined first set of risk mitigation techniques.

13. The system of claim 12, wherein the processor set is further configured to:
retrieve one or more scores associated with the one or more elements based on the received first input, wherein the one or more scores are retrieved from one or more data sources;
determine a combination operator based on the received first input; and
calculate the first risk score based on the retrieved one or more scores and the determined combination operator.

14. The system of claim 13, wherein the calculation of the first risk score is based on an application of the determined combination operator on the retrieved one or more scores, and wherein the determined combination operator corresponds to one of an additive operator, a multiplier operator, or an exponential operator.

15. The system of claim 13, wherein the processor set is further configured to:
determine a first value of a first element of the one or more elements based on the received first input;
determine a second value of the first element of the one or more elements based on the received first input, wherein the received first input comprises the second value; and
retrieve a first score of the one or more scores associated with the first element based on the determined first value and the determined second value, wherein the first score associated with the update of the first element from the first value to the second value is stored in the one or more data sources.

16. The system of claim 13, wherein the processor set is further configured to:
identify an absence of a score associated with at least one element of the plurality of elements associated with the configuration of the application hosted on the container platform; and
assign a default score with each of the at least one element based on the identification.

17. The system of claim 13, wherein the processor set is further configured to:
execute each of the first set of risk mitigation techniques before the update of the application;
update the application based on the execution of each of the first set of risk mitigation techniques;
determine a first result indicative of one of a success or a failure associated with the update of the application; and
update the one or more scores based on the determined first result.

18. The system of claim 12, wherein the processor set is further configured to:
receive a second input associated with a selection of one or more risk mitigation techniques of the determined first set of risk mitigation techniques; and
execute the selected one or more risk mitigation techniques based on the received second input, wherein the selected one or more risk mitigation techniques are to be executed before the update of the application.

19. The system of claim 12, wherein the first set of risk mitigation techniques comprises at least one of a creation of a backup of data associated with the application, a creation of a backup of the configuration associated with the application, generation of one or more snapshots associated with the application, execution of one or more preparatory checks, or creation of a set of canary applications associated with the application hosted on the container platform.

20. A computer program product for determination of a first set of risk mitigation techniques to be executed before an update of an application hosted on a container platform, the computer program product comprising a computer-readable storage medium having program instructions embodied therewith, the program instructions executable by a system to cause the system to:
receive a first input associated with an update of one or more elements of a plurality of elements associated with a configuration of an application hosted on a container platform;
calculate a first risk score based on the received first input, the first risk score is associated with the update of the one or more elements of the plurality of elements associated with the configuration of the application;
determine a first set of risk mitigation techniques based on the calculated first risk score, wherein the determined first set of risk mitigation techniques are to be executed before an update of the application; and
output the determined first set of risk mitigation techniques.
